(19) United States
(12) Patent Application Publication
(10) Pub. No.: US 2026/0077553 A1
(43) Pub. Date: Mar. 19, 2026

(54) SHAPED-OBJECT MANUFACTURING DEVICE AND SHAPED-OBJECT MANUFACTURING METHOD

(71) Applicant: MIMAKI ENGINEERING CO., LTD., Nagano (JP)

(72) Inventor: Kenta Hongo, Nagano (JP)

(21) Appl. No.: 19/106,231

(22) PCT Filed: Aug. 23, 2023
(86) PCT No.: PCT/JP2023/030370

§ 371 Date: Feb. 25, 2025

(30) Foreign Application Priority Data
Sep. 26, 2022 (JP) 2022-152426

(51) Int. Cl. B29C 64/218; B29C 64/112; B29C 64/209; B33Y 10/00; B33Y 30/00

(52) U.S. Cl. CPC B29C 64/218; B29C 64/112; B29C 64/209; B33Y 10/00; B33Y 30/00

(57) ABSTRACT

A shaped-object manufacturing device 1 that shapes a three-dimensional shaped object 7 includes: a liquid storage 5 that retains a liquid 6; a head unit 2 that ejects an ink to the liquid 6; and a roller 301 that comes into contact with the ink retained by a liquid surface 60 of the liquid 6.

### CROSS-REFERENCE TO RELATED APPLICATION

This application is a 371 application of the International PCT application serial no. PCT/JP2023/030370, filed on Aug. 23, 2023, which claims the priority benefit of Japan application no. 2022-152426, filed on Sep. 26, 2022. The entirety of each of the above-mentioned patent application is hereby incorporated by reference herein and made a part of this specification.

### TECHNICAL FIELD

The present invention relates to a shaped-object manufacturing device and a shaped-object manufacturing method.

### BACKGROUND ART

Patent Literature 1 discloses a shaped-object manufacturing method for shaping a shaped object by layering a modeling material and a support material on a shaping table. In a plurality of layers formed of the modeling material, when there is a portion in which an upper layer overhangs a lower layer, it is easily affected by gravity. In Patent Literature 1, the overhanging portion is supported by a support material. Patent Literature 2 discloses a method for removing a support material from a shaped object shaped by a 3D printer using a support material removing liquid.

### CITATION LIST

### Patent Literature

Patent Literature 1: Japanese Unexamined Patent Publication No. 2021-146641
Patent Literature 2: Japanese Unexamined Patent Publication No. 2018-83869

### SUMMARY OF INVENTION

### Technical Problems

In the manufacture of the shaped object, the time required for removing the support material is a loss. A waste liquid from which the support material is removed requires an industrial waste process, which takes time and cost.

Here, in order to perform stable layering, an ink constituting the modeling material is flattened by a roller. When the support material is not used, the ink constituting the overhang portion is not supported on the lower layer; thus, there is no ink that receives a contact pressure with the roller, and it is considered that the ink is not flattened.

Therefore, it is required to flatten the ink constituting the overhang portion in each layer of the modeling material without using the support material.

### Solutions to Problems

The present invention provides
a shaped-object manufacturing device that shapes a three-dimensional shaped object, the shaped-object manufacturing device including:
a liquid storage that retains a liquid;
an ejector that ejects an ink to the liquid; and
a roller that comes into contact with the ink retained by a liquid surface of the liquid.

According to the present invention, the ink retained by the liquid surface comes into contact with the roller in a state where buoyancy acts from the liquid. Therefore, the ink constituting the overhang portion can be flattened in each layer of the modeling material without using the support material.

In the shaped-object manufacturing device according to one mode of the present invention,
the roller is provided to be relatively movable with respect to the liquid storage, and
when viewed from the liquid storage, the roller rotates so that a portion in contact with the ink is oriented in a direction of the relative movement.

According to the present invention, the smoothness of the ink of the portion in contact with the roller is improved.

In the shaped-object manufacturing device according to one mode of the present invention,
the roller is provided to be relatively movable with respect to the liquid storage, and
when viewed from the liquid storage, the roller rotates so that a portion in contact with the ink is oriented in a direction opposite to the direction of the relative movement.

According to the present invention, mixing of the ink is small at the portion in contact with the roller.

In the shaped-object manufacturing device according to one mode of the present invention,
the roller includes an adjustment mechanism that adjusts a contact pressure with the ink.

According to the present invention, it is possible to reduce a displacement of the position of the ink on the liquid surface.

In the shaped-object manufacturing device according to one mode of the present invention,
a curing unit that cures the ink.

According to the present invention, the flattened ink can be sequentially layered.

In the shaped-object manufacturing device according to one mode of the present invention,
the ejector is an inkjet head.

According to the present invention, fine color expression and fine shaping can be performed by ejecting the ink from the inkjet head.

The present invention provides
a shaped-object manufacturing method for shaping a three-dimensional shaped object, the shaped-object manufacturing method including:
an ejecting step of ejecting an ink to a liquid stored in a liquid storage;
a flattening step of flattening the ink retained by a liquid surface of the liquid by a roller; and
a curing step of curing the flattened ink to form an ink layer.

According to the present invention, the ink retained by the liquid surface is flattened by the roller in a state where buoyancy acts from the liquid and then cured. Therefore, flattening and curing of the ink constituting the overhang portion can be performed in each layer of the modeling material without using the support material.

In the shaped-object manufacturing method according to one mode of the present invention,
the roller is moved relative to the liquid storage, and
when viewed from the liquid storage, the roller is rotated so that a portion in contact with the ink is oriented in a direction of the relative movement.

According to the present invention, the smoothness of the ink of the portion in contact with the roller is improved.

In the shaped-object manufacturing method according to one mode of the present invention,
the roller is moved relative to the liquid storage, and
when viewed from the liquid storage, the roller is rotated so that a portion in contact with the ink is oriented in a direction opposite to the direction of the relative movement.

According to the present invention, mixing of the ink is small at the portion in contact with the roller.

In the shaped-object manufacturing method according to one mode of the present invention,
an adjustment step of adjusting a contact pressure between the roller and the ink is further included.

According to the present invention, it is possible to reduce a displacement of the position of the ink on the liquid surface.

In the shaped-object manufacturing method according to one mode of the present invention,
a method for ejecting the ink is an inkjet method.

According to the present invention, since the surface of the shaped object is not affected by the support material, fine color expression and fine shaping expression, which are advantages of the inkjet method, can be utilized.

### Effect of the Invention

According to the present invention, the ink constituting the overhang portion can be flattened in each layer of the modeling material without using the support material.

### BRIEF DESCRIPTION OF THE DRAWINGS

FIG. 1A and FIG. 1B are views illustrating a shaped-object manufacturing device.

FIG. 2 is a view illustrating a liquid storage.

FIG. 3 is a view illustrating a liquid storage.

FIG. 4A and FIG. 4B are views illustrating slice data of a shaped object.

FIG. 5A and FIG. 5B are views illustrating a shaped-object manufacturing method.

FIG. 6A and FIG. 6B are views illustrating a shaped-object manufacturing method.

FIG. 7A and FIG. 7B are views illustrating a shaped-object manufacturing method.

FIG. 8A, FIG. 8B, and FIG. 8C are views illustrating a shaped-object manufacturing device according to Modification 1.

FIG. 9 is a view illustrating a shaped-object manufacturing device according to Modification 2.

FIG. 10 is a view illustrating a shaped-object manufacturing device according to Modification 3.

FIG. 11 is a view illustrating a shaped-object manufacturing device according to Modification 4.

FIG. 12 is a view illustrating slice data of the shaped object according to Modification 4.

FIG. 13A, FIG. 13B, and FIG. 13C are views illustrating a shaped-object manufacturing method according to Modification 4.

FIG. 14A and FIG. 14B are views illustrating a shaped-object manufacturing method according to Modification 4.

FIG. 15A, FIG. 15B, and FIG. 15C are views illustrating a shaped-object manufacturing method according to Modification 5.

FIG. 16 is a view illustrating a shaped object according to Modification 6.

FIG. 17 is a view illustrating slice data of the shaped object according to Modification 6.

FIG. 18A and FIG. 18B are views illustrating a shaped-object manufacturing method according to Modification 6.

FIG. 19 is a view illustrating a shaped-object manufacturing method according to Modification 7.

FIG. 20 is a view illustrating a shaped-object manufacturing method according to Modification 8.

### DESCRIPTION OF EMBODIMENTS

Hereinafter, a manufacturing device 1 that shapes a three-dimensional shaped object 7 by an inkjet method will be described as an example.

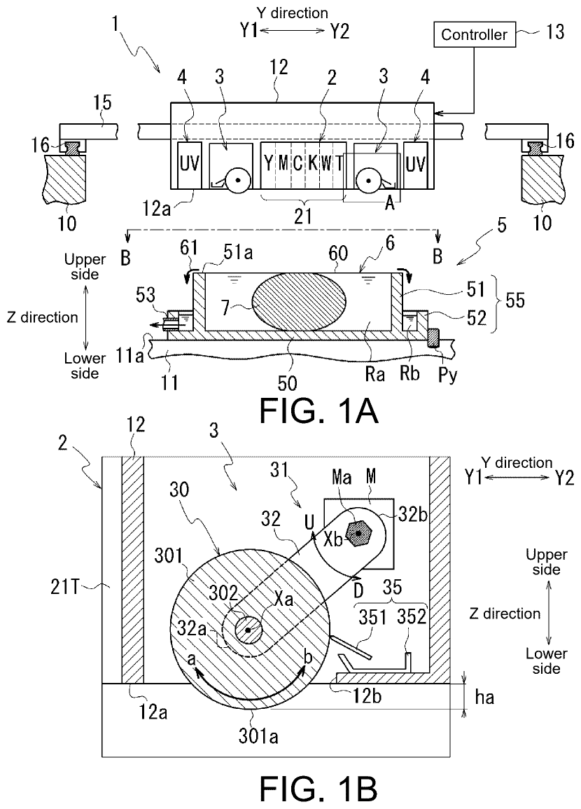

FIG. 1A and FIG. 1B are views illustrating the manufacturing device 1. FIG. 1A is a schematic configuration view of the manufacturing device 1. FIG. 1B is a view illustrating a roller unit 3. FIG. 1B is an enlarged view of the region A in FIG. 1A.

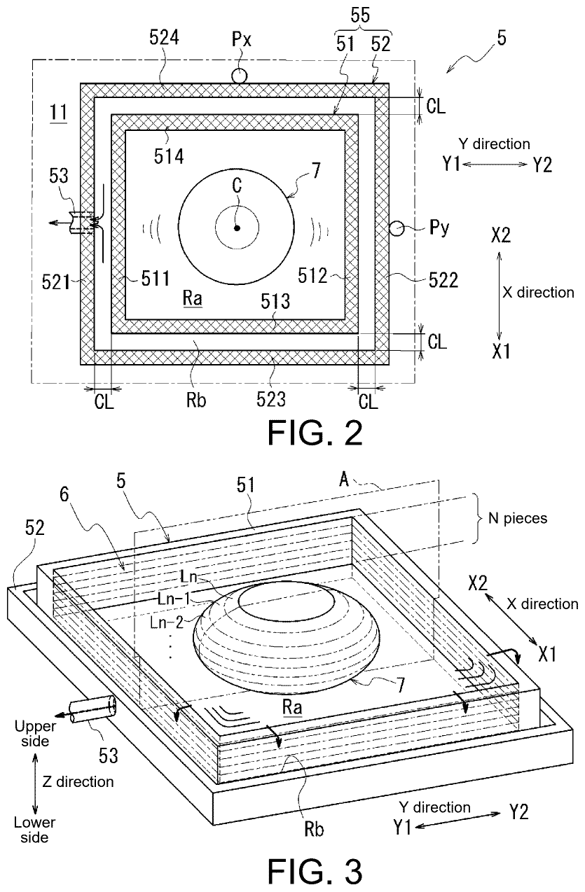

FIG. 2 is a view illustrating a liquid storage 5. FIG. 2 is a view taken along the B-B arrow in FIG. 1A.

FIG. 3 is a perspective view illustrating the liquid storage 5.

Note that, in the following description, the “Y direction” means a main scanning direction of the manufacturing device 1. The main scanning direction is a left-right direction when the manufacturing device 1 is viewed from the front. The “X direction” means a sub-scanning direction. The sub-scanning direction is a direction orthogonal to the main scanning direction, and is a direction from the front side to the back side of the manufacturing device 1. The “Z direction” means a vertical line direction when the manufacturing device 1 is placed on a horizontal plane. In addition, the “Y1 side” means one side (left side in FIG. 1A) in the Y direction when the manufacturing device 1 is viewed from the front, and “Y2 side” means the other side (right side in FIG. 1A). The “X1 side” means the front side (lower side in FIG. 2) of the manufacturing device 1, and the “X2 side”means the back side (upper side in FIG. 2).

As illustrated in FIG. 1A, the manufacturing device 1 includes a table 11, a carriage 12 disposed movably in the Y direction above the table 11, and a controller 13 that controls the manufacturing device 1. The liquid storage 5 used when manufacturing the shaped object 7 is placed on the table 11.

A guide rail 15 disposed in the Y direction is provided above the table 11. The guide rail 15 guides the movement of the carriage 12 in the Y direction.

Both ends of the guide rail 15 in the Y direction are supported by guide rails 16 and 16. The guide rails 16 and 16 are disposed in the X direction. The guide rails 16 and 16 are fixed to body frames 10 and 10 of the manufacturing device 1, respectively. The guide rails 16 and 16 guide the movement of the guide rail 15 and the carriage 12 in the X direction.

The manufacturing device 1 includes a moving mechanism that moves the carriage 12 in the Y direction. Although not illustrated, the moving mechanism includes a belt provided in a direction along the Y direction, a driving pulley and a driven pulley around which the belt is wound, and a motor that rotates the driving pulley. The carriage 12 is fixed to the belt. The carriage 12 moves in the Y direction along the guide rail 15 by driving the motor to rotate the belt based on a command from the controller 13.

In addition, the manufacturing device 1 includes a feeding mechanism that moves the guide rail 15 in the X direction. Although not illustrated, the feeding mechanism includes a belt provided in a direction along the X direction, a driving pulley and a driven pulley around which the belt is wound, and a motor that rotates the driving pulley. The guide rail 15 is fixed to the belt. The guide rail 15 moves in the X direction together with the carriage 12 along the guide rails 16 and 16 by driving the motor to rotate the belt based on a command from the controller 13.

The head unit 2 (ejector), the roller unit 3, and an ultraviolet irradiation unit 4 (curing unit) are mounted on the carriage 12.

The head unit 2 is an inkjet head that ejects ink. In the present embodiment, a case of using an ultraviolet curable ink will be exemplified. The roller unit 3 flattens the ink ejected from the head unit 2. The ultraviolet irradiation unit 4 irradiates the ink with ultraviolet UV rays to cure the ink.

The roller unit 3 and the ultraviolet irradiation unit 4 are provided on one side and the other side of the head unit 2 in the Y direction, respectively. The roller units 3 and 3 are disposed closer to the head unit 2 than the ultraviolet irradiation units 4 and 4 in the Y direction.

The head unit 2 includes coloring heads 21Y, 21M, 21C, and 21K that eject yellow (Y), magenta (M), cyan (C), and black (K) inks, respectively, as inks for a modeling material, a white head 21W that ejects a white (W) ink, and a clear head 21T that ejects a transparent ink containing no coloring component. The carriage 12 is provided with these heads 21 (21Y, 21M, 21C, 21K, 21W, and 21T), the roller units 3 and 3, and the ultraviolet irradiation units 4 and 4 arranged in the Y direction. In the drawing, only “Y, M, C, K, W, and T” at the end are illustrated for reference signs 21Y, 21M, 21C, 21K, 21W, and 21T.

Note that, in the present embodiment, a viscosity of the ink is set to be 15 mPa·s or more and 30 mPa·s or less at a temperature of the ink of 45° C. In addition, a specific gravity of the ink with a liquid 6 to be described below is preferably set to be 1.04 g/cm³ or more and 1.12 g/cm³ or less before curing, and is preferably set to be 1.12 g/cm³ or more and 1.20 g/cm³ or less after curing.

Note that, although not illustrated, each nozzle surface of the head 21 (21Y, 21M, 21C, 21K, 21W, or 21T) is exposed to the outside of the carriage 12 from a bottom surface 12a of the carriage 12. Each nozzle surface is provided with a plurality of nozzle holes in the X direction. The ink of each color is ejected from the nozzle hole toward the table 11.

The ultraviolet irradiation unit 4 irradiates the ink ejected from the head unit 2 with ultraviolet UV rays. As a light source of ultraviolet UV rays, a metal halide lamp or an ultraviolet LED is used.

As illustrated in FIG. 1B, the roller unit 3 includes a roller portion 30, an adjustment portion 31 (adjustment mechanism), and a cleaning portion 35. The roller portion 30 levels and flattens the ejected ink. The adjustment portion 31 adjusts a contact pressure between the roller portion 30 and the ink. The cleaning portion 35 removes the ink attached to the roller portion 30.

The roller portion 30 includes a shaft 302 provided in a direction along the X direction, and a roller 301 that is externally fitted to the shaft 302 and rotates integrally with the shaft 302. An outer peripheral surface 301a of the roller 301 is parallel to an axis Xa. In the outer peripheral surface 301a of the roller 301, a region below the axis Xa protrudes toward the table 11 from an opening 12b provided in the bottom surface 12a of the carriage 12. A motor (not illustrated) is connected to the shaft 302, and when the motor operates based on a command from the controller 13, the motor rotates about the axis Xa together with the roller 301 (in the drawing, the arrow a direction or the arrow b direction).

The adjustment portion 31 includes a motor M fixed to a wall portion on the back side of the drawing of the carriage 12, and an arm portion 32 provided across the motor M and the shaft 302.

A drive shaft Ma of the motor M is provided in a direction along the X direction. When viewed from the shaft 302, the drive shaft Ma of the motor M is provided above the roller 301. In addition, when viewed from the shaft 302, the drive shaft Ma of the motor M is provided on the side opposite to the head unit 2.

The arm portion 32 is connected to the drive shaft Ma of the motor M on the other end 32b so as to be relatively non-rotatable. In addition, the arm portion 32 supports the shaft 302 so as to be relatively rotatable on one end 32a.

The adjustment portion 31 drives the motor M based on a command from the controller 13 while supporting the roller portion 30 on one end 32a of the arm portion 32, and rotates the arm portion 32 about an axis Xb (in the drawing, the arrow U direction or the arrow D direction). Thus, a protrusion amount ha of the roller 301 from the bottom surface 12a of the carriage 12 is adjusted.

The cleaning portion 35 includes a wiper 351 and a tray 352. The wiper 351 and the tray 352 are provided in a direction along a radial direction of the axis Xa. The roller 301, the wiper 351, and the tray 352 are arranged in this order from the radially inner side to the radially outer side of the axis Xa.

The cleaning portion 35 removes the ink attached to the outer peripheral surface 301a of the roller 301 with the wiper 351, and collects the removed ink by the tray 352. A drain hose (not illustrated) is connected to the tray 352. The ink collected by the tray 352 is discharged from the drain hose.

As illustrated in FIG. 1A, the liquid storage 5 is provided below the carriage 12. The liquid storage 5 is disposed on the table 11. The liquid storage 5 is a tank body having an open upper portion, and is filled with the liquid 6. In the liquid storage 5, the shaped object 7 is immersed in the liquid 6.

As illustrated in FIG. 1A, the liquid storage 5 includes a bottom wall portion 50 in contact with an upper surface 11a of the table 11, and a peripheral wall portion 55 surrounding an outer periphery of the bottom wall portion 50. The peripheral wall portion 55 extends upward in the Z direction from the bottom wall portion 50.

As illustrated in FIG. 2, the peripheral wall portion 55 has a rectangular shape in plan view.

Specifically, the peripheral wall portion 55 includes a first peripheral wall portion 51 surrounding the shaped object 7 and a second peripheral wall portion 52 surrounding the first peripheral wall portion 51. In FIG. 2, the first peripheral wall portion 51 and the second peripheral wall portion 52 are cross-hatched for easy viewing.

The first peripheral wall portion 51 includes wall portions 511 and 512 provided in a direction along the X direction and wall portions 513 and 514 provided in a direction along the Y direction and connecting end portions of the wall portions 511 and 512.

The second peripheral wall portion 51 includes wall portions 521 and 522 provided in a direction along the X direction and wall portions 523 and 524 provided in a direction along the Y direction and connecting end portions of the wall portions 521 and 522. The wall portions 521 to 524 of the second peripheral wall portion 52 are provided in parallel with the wall portions 511 to 514 of the first peripheral wall portion 51 with a gap CL therebetween.

As illustrated in FIG. 1A, the liquid storage 5 has a space Ra inside the first peripheral wall portion 51 and a space Rb between the first peripheral wall portion 51 and the second peripheral wall portion 52. The liquid 6 is stored in the space Ra. The space Rb collects the liquid 6 overflowing from the space Ra.

As illustrated in FIGS. 2 and 3, a drain hose 53 penetrating the wall portion 521 in the Y direction is connected to the wall portion 521 of the second peripheral wall portion 52. The drain hose 53 communicates with the space Rb. The liquid 6 overflowing from the space Ra is collected in the space Rb and then discharged from the drain hose 53 to the outside. That is, the space Rb and the drain hose 53 constitute a collecting unit that collects the liquid 6 overflowing from the space Ra.

As illustrated in FIG. 2, the table 11 is provided with positioning pins Px and Py. The positioning pins Px and Py protrude upward in the Z direction from the upper surface 11a of the table 11 (see FIG. 1A).

As illustrated in FIG. 2, as for the liquid storage 5, the liquid storage 5 can be disposed at a predetermined position on the table 11 by bringing the wall portion 522 of the second peripheral wall portion 52 into contact with the positioning pin Py in the Y2 direction and bringing the wall portion 524 into contact with the positioning pin Px in the X2 direction.

Thus, the space Ra of the liquid storage 5 is located in a preset ink ejection region (a region where the shaped object 7 is formed) when viewed from the Z direction.

As illustrated in FIG. 3, the inside of the first peripheral wall portion 51 of the liquid storage 5 is filled with the liquid 6. As illustrated in FIG. 1A, a liquid surface 60 of the liquid 6 is flush with an upper surface 51a of the first peripheral wall portion 51. In this state, the shaped object 7 is immersed in the liquid 6 in the space Ra inside the first peripheral wall portion 51.

The liquid 6 preferably has a viscosity at which the shaped object 7 in the liquid 6 does not move in a short period of time such as immediately after landing of the ink, but finally moves (sinks) in the Z direction in order to layer an ink layer.

Specifically, the viscosity of the liquid 6 is preferably more than 0 Pa s and 100 Pa·s or less, and particularly preferably more than 0 Pa·s and 1 Pa·s or less.

Therefore, the liquid 6 according to the present embodiment contains polyvinyl alcohol (PVA), borax, and water, and has a predetermined viscosity included in the above range. In addition, the liquid 6 may be a mixture of water, flour, soybean flour, and starch, or a mixture of a resin material (a monomer or an oligomer) and a filler.

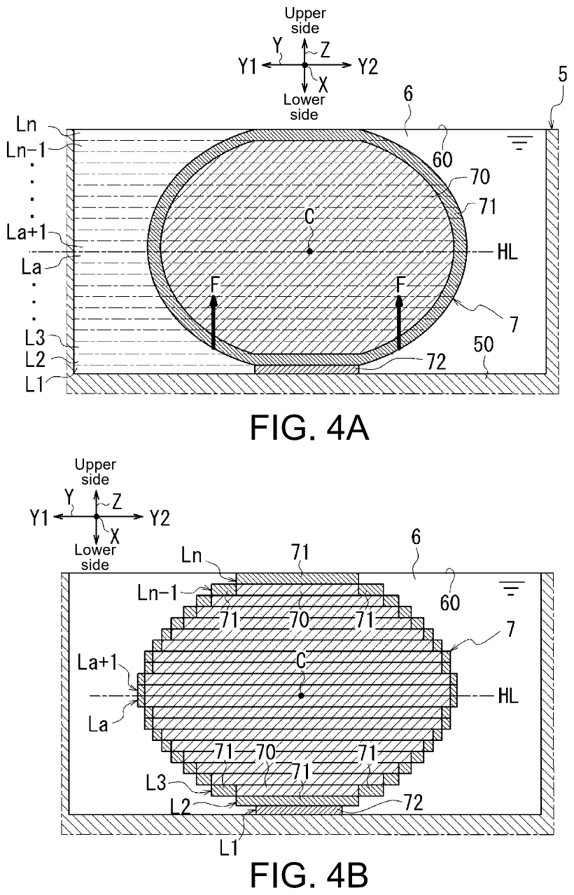

FIG. 4A and FIG. 4B are views illustrating slice data of the shaped object 7. FIG. 4A is a schematic cross-sectional view of the shaped object 7 taken along the plane A in the Y direction of FIG. 3. FIG. 4B is three-dimensional data when the shaped object 7 is created by the manufacturing device 1, and is slice data corresponding to the cross section illustrated in FIG. 4A.

As illustrated in FIG. 4A, the shaped object 7 includes a solid portion 70 and a color portion 71 that covers the solid portion 70. In addition, an ejection table 72 is interposed between the shaped object 7 and the bottom wall portion 50 of the liquid storage 5. The ejection table 72 is a flat plate for uniformly applying buoyancy to the shaped object 7 in the middle of manufacturing. The ejection table 72 may be a part of the shaped object 7, or may be cut after manufacturing the shaped object 7.

The solid portion 70 is a central region of the shaped object 7, and is formed with an outer shape corresponding to the shape of the shaped object 7. The solid portion 70 is formed of, for example, a white (W) ink.

The color portion 71 and the ejection table 72 are regions formed by curing of colored inks such as yellow (Y), magenta (M), cyan (C), and black (K). The color portion 71 covers the entire surface of the solid portion 70. The color portion 71 includes inks such as yellow (Y), magenta (M), cyan (C), and black (K) at predetermined ratios determined according to the color to be realized, and the color exhibited by the color portion 71 appears on the surface of the shaped object 7.

Note that the inks used in the color portion 71 are not limited to the inks such as yellow (Y), magenta (M), cyan (C), and black (K) described above. The clear (T) ink and the white (W) ink may be included. Furthermore, a red (R) ink, a green (G) ink, and a blue (B) ink may be included.

As illustrated in FIG. 4A, in the manufacturing device 1, the shaped object 7 is sliced (partitioned) at equal intervals in the Z direction, and N ink layers (L1 to Ln: n is an arbitrary integer) are set. The shaped object 7 is created by sequentially layering the ink layers from the ink layer L1 on the bottom wall portion 50 of the liquid storage 5 to the ink layer Ln on the liquid surface 60 of the liquid 6.

As illustrated in FIG. 4B, the ejection table 72 is formed on the ink layer L1. The color portion 71 is formed on the ink layer L2 and the ink layer Ln. The solid portion 70 and the color portion 71 are formed in the ink layer L3 to the ink layer Ln−1.

As illustrated in FIG. 4A, the shaped object 7 according to the present embodiment is formed to spread in the X direction and the Y direction from the lower side toward the upper side in the Z direction in the ink layers (L1 to La) in the region below a horizontal line HL passing through the center C of the shaped object 7 (for example, the ink layer L2 viewed from the ink layer L1 or the ink layer L3 viewed from the ink layer L2). Therefore, the shaped object 7 has a portion in which the upper layer overhangs the lower layer. The shaped object 7 according to the present embodiment reduces the influence of gravity without using a conventional support material by applying buoyancy F of the liquid 6 to the overhanging portion.

Hereinafter, a manufacturing method of a shaped object 7 by the manufacturing device 1 will be described.

Hereinafter, as the manufacturing method of the shaped object 7, a case of forming the ink layer L1 to the ink layer L3 illustrated in FIG. 4B will be described as an example.

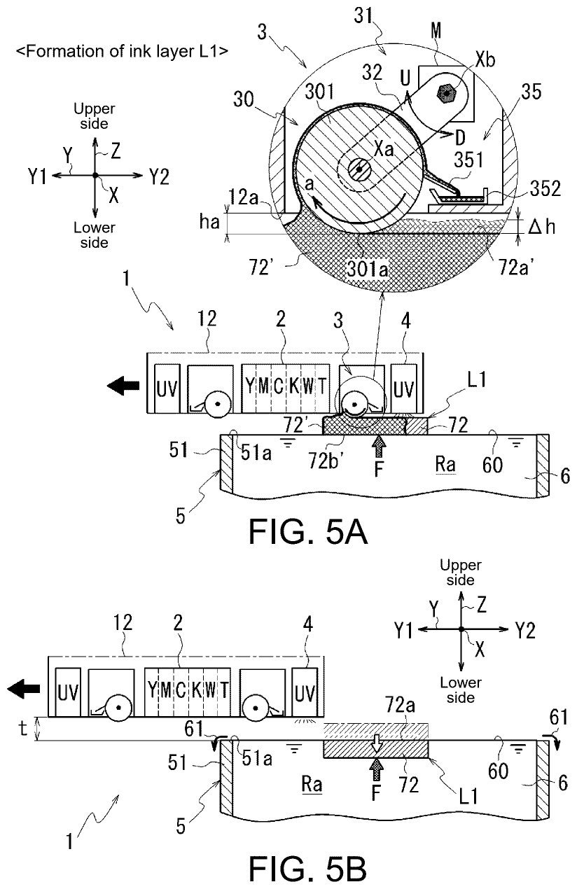

FIGS. 5A to 7B are views for sequentially explaining the formation of the ink layer L1 to the ink layer L3 based on the slice data illustrated in FIG. 4B. Note that, in FIGS. 5A to 7B, in the ink layer L1 to the ink layer L3, an uncured region is cross-hatched, and a cured region is hatched. In addition, the uncured region in each portion of the shaped object 7 is denoted with “′” attached to the reference sign.

The ink layers are preferably layered on a horizontal plane in order to uniformly apply the buoyancy of the liquid 6. In the present embodiment, in order to secure a horizontal plane, the ejection table 72 is provided as the ink layer L1 that is the lowermost layer (see FIG. 4B). That is, the ejection table 72 is formed prior to the shaping of the shaped object 7 (table forming step). Note that, in the present embodiment, an area of the ejection table 72 is made smaller than an area of the ink layer L2 in order to describe the overhang, but the area of the ejection table 72 may be the same as or larger than the area of the ink layer L2.

### Formation of Ink Layer L1

FIG. 5A and FIG. 5B are views illustrating the formation of the ink layer L1. FIG. 5A is a view illustrating flattening of the ink by the roller unit 3. FIG. 5B is a view illustrating the ink layer L1 after curing.

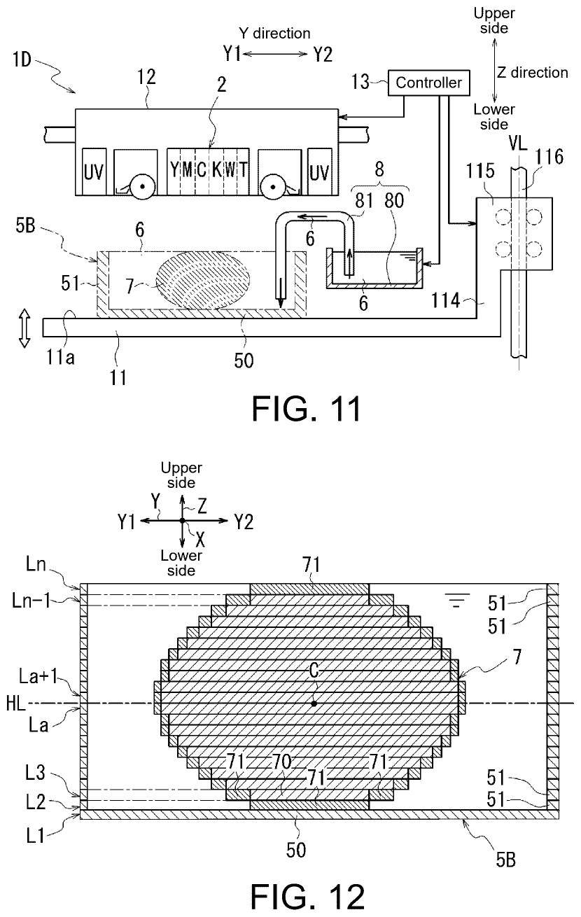

As illustrated in FIG. 5A, the shaped object 7 is manufactured in a state where the space Ra of the liquid storage 5 is filled with the liquid 6 in advance. The liquid surface 60 of the liquid 6 is flush with the upper surface 51a of the first peripheral wall portion 51 of the liquid storage 5. Note that the supply of the liquid 6 may be manually performed by an operator, or a supplying unit 8 (see FIG. 11) to be described below may be used.

As illustrated in FIG. 5A, the manufacturing device 1 ejects the ink from the head unit 2 toward the liquid 6 while moving the carriage 12 in the Y1 direction (in the drawing, the black arrow direction) (ejecting step). An uncured ink lands on the liquid surface 60 of the liquid 6.

As described above, the viscosity of the liquid 6 is set to be more than 0 Pa·s and 100 Pa·s or less. Specifically, the viscosity of the ink is set to be 15 mPa·s or more and 30 mPa·s or less at a temperature of the ink of 45° C. The specific gravity of each of the ink and the liquid 6 is set to be 1.04 g/cm³ or more and 1.12 g/cm³ or less before the ink is cured, and is set to 1.12 g/cm³ or more and 1.20 g/cm³ or less after the ink is cured.

Therefore, the ink landed on the liquid surface 60 is retained at a predetermined landing position in the X and Y directions without diffusing on the liquid surface 60. In addition, the uncured ink has a smaller specific gravity than the liquid 6. Therefore, the buoyancy Facts on a lower surface 72b′ of an ejection table 72′ including an uncured ink from the liquid 6 (in the drawing, the hatched arrow). Therefore, the ejection table 72′ floats on the liquid surface 60.

In addition, the manufacturing device 1 flattens the ejection table 72′ by the roller unit 3 while moving the carriage 12 in the Y1 direction (flattening step).

Specifically, as illustrated in the enlarged region of FIG. 5A, while rotating the roller 301 about the axis Xa, the outer peripheral surface 301a is brought into contact with the ejection table 72′ to scrape an upper portion of the ejection table 72′. Thus, an upper surface 72a′ of the ejection table 72′ after passing the roller portion 30 becomes a horizontal plane along the X and Y directions.

In the present embodiment, a rotation direction of the roller 301 is rotated so as to be a direction along a moving direction (Y1 direction) of the carriage 12 (arrow a direction). Thus, the smoothness of the upper surface 72a′ of the ejection table 72′ can be improved.

Note that the rotation direction of the roller 301 may be rotated so as to be a direction opposite to the moving direction (Y1 direction) of the carriage 12 (arrow b direction; see FIG. 1B). In this case, mixing of the ink constituting the ejection table 72′ is small.

Here, the ejection table 72′ floating on the liquid surface 60 may be pushed by contact with the roller 301, and may be displaced. Therefore, the contact pressure between the roller 301 and the ejection table 72′ can be adjusted by operating the adjustment portion 31 to adjust a bite amount Δh of the roller 301 into the ejection table 72′ in the Z direction.

Note that examples of the contact pressure include a method in which a sensor is provided in a motor that drives the roller portion 30, and a load torque applied to the motor is measured when the ink is scraped off by the roller 301.

For example, in a case where the ejection table 72′ moves on the liquid surface 60 by the roller portion 30, it is considered to reduce the contact pressure to cope with the case. In this case, the bite amount Δh may be reduced. Specifically, the motor M of the adjustment portion 31 is driven to rotate the arm portion 32 upward (in the arrow U direction) about the axis Xb, such that the protrusion amount ha of the roller 301 from the bottom surface 12a of the carriage 12 is reduced. Thus, the bite amount Δh is reduced, and the ink can be scraped off in a state where the contact pressure is lowered, such that the movement of the ejection table 72′ on the liquid surface 60 can be reduced.

Note that the number of paths may be increased by the amount by which the bite amount Δh is reduced until the ejection table 72′ reaches a predetermined thickness to scrape the ink. In this case, the arm portion 32 may be displaced little by little toward the lower side (the arrow D direction) around the axis Xb for each pass.

On the other hand, when the viscosity of the liquid 6 is increased to make it difficult for the ejection table 72′ to move on the liquid surface 60, the bite amount Δh can be increased to increase the contact pressure. Specifically, the protrusion amount ha of the roller portion 30 from the bottom surface 12a of the carriage 12 increases by driving the motor M to rotate the arm portion 32 toward the lower side (in the arrow D direction) about the axis Xb. Thus, since the bite amount Δh increases, the time required for flattening the ejection table 72′ can be shortened.

The ink scraped off by the roller 301 moves in a circumferential direction around the axis Xa in accordance with the rotation of the roller 301 in a state of being attached to the outer peripheral surface 301a. The wiper 351 of the cleaning portion 35 comes into contact with the outer peripheral surface 301a below the ejection table 72′ in the circumferential direction around the axis Xa. Therefore, the ink attached to the outer peripheral surface 301a of the roller 301 is separated from the roller 301 by the wiper 351 and then collected on the tray 352.

In addition, while moving the carriage 12 in the Y1 direction, the manufacturing device 1 irradiates the ejection table 72′ that is flattened with ultraviolet UV rays from the ultraviolet irradiation unit 4 (curing step). Thus, the ejection table 72 formed of the cured ink is formed as the ink layer L1.

The specific gravity of the cured ink is set to be larger than that of the liquid 6. Therefore, the cured ink sinks in the liquid 6.

Specifically, as illustrated in FIG. 5B, the ejection table 72 after curing sinks toward the lower side in the Z direction by its own weight in a state where the positions in the X and Y directions are retained (in the drawing, the white arrow). In this case, the ejection table 72 is balanced with the buoyancy F at a position where the upper surface 72a is flush (the same surface) with the liquid surface 60.

Note that, after the ejection table 72 is formed, the carriage 12 may be moved in the Y2 direction, and the ejection table 72 may be pushed into the liquid 6 by the roller unit 3 so that the upper surface 72a and the liquid surface 60 are flush with each other.

Thus, it is possible to use the high-viscosity liquid 6 that is less likely to sink under its own weight of the ejection table 72, and the ejection table 72 is less likely to be displaced. In addition, since the liquid surface 60 is also flattened, the accuracy of forming the next ink layer L2 is also improved.

Then, the liquid 61 overflows from the space Ra of the liquid storage 5 by the volume by which the ink layer L1 (ejection table 72) sinks in the liquid 6. Thus, the liquid surface 60 of the liquid 6 is maintained to be flush with the upper surface 51a of the first peripheral wall portion 51 of the liquid storage 5. Thus, a distance t between the head unit 2 and the liquid surface 60 of the liquid 6 in the Z direction can be maintained constant, such that the landing accuracy of the ink in the ejecting step can be maintained.

As illustrated in FIG. 1A, the liquid 61 overflowing from the space Ra is stored in the space Rb of the liquid storage 5, and finally discharged to the outside through the drain hose 53 (discharging step).

Note that the discharged liquid 6 may be discarded or reused.

### Formation of Ink Layer L2

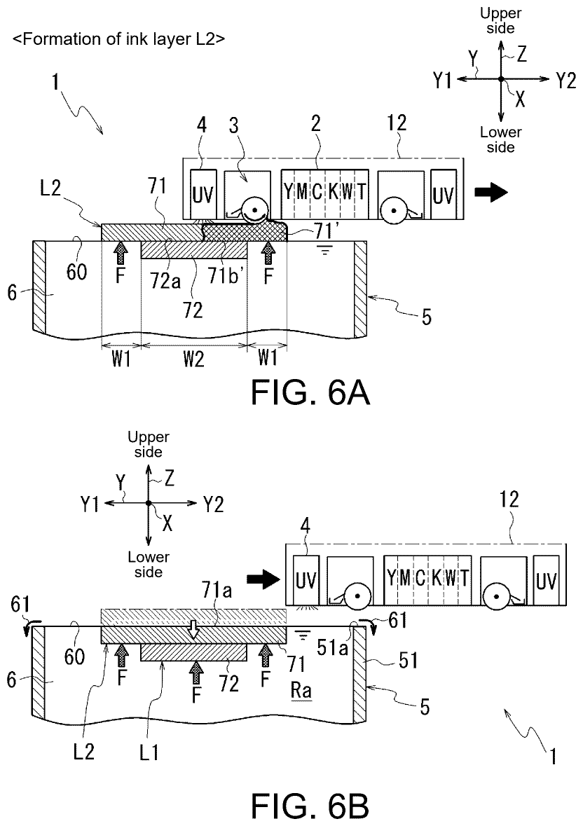

FIG. 6A and FIG. 6B are views illustrating the formation of the ink layer L2. FIG. 6A is a view illustrating the ejection of the ink. FIG. 6B is a view illustrating the ink layer L2.

As illustrated in FIG. 6A, the manufacturing device 1 ejects the ink from the head unit 2 toward the liquid 6 while moving the carriage 12 in the Y2 direction (in the drawing, the black arrow).

As illustrated in FIG. 4B, the color portion 71 of the ink layer L2 has a larger area than the ejection table 72, and is provided in a range crossing the ejection table 72 in the Y direction. Therefore, as illustrated in FIG. 6A, the ink ejected from the head unit 2 lands in a range across the upper surface 72a of the ejection table 72 provided on the same plane and the liquid surface 60 of the liquid 6.

Therefore, as illustrated in FIG. 6A, a color portion 71′ has overhang regions W1 and W1 projecting in the Y direction from the ejection table 72, and an overlap region W2 overlapping the ejection table 72. In a lower surface 71b′ of the color portion 71′, the overhang regions W1 and W1 are in contact with the liquid surface 60 of the liquid 6, and the overlap region W2 is in contact with the upper surface 72a of the ejection table 72.

That is, the overhang regions W1 and W1 of the color portion 71′ are aligned with the overlap region W2 in the Z direction.

The buoyancy F acts on the overhang regions W1 and W1 of the lower surface 71b′ of the color portion 71′ from the liquid 6 (in the drawing, the hatched arrow). The overlap region W2 of the lower surface 71b′ of the color portion 71′ is supported by the ejection table 72. Therefore, the color portion 71′ is maintained in a state parallel to the liquid surface 60 (horizontal state) over the entire length in the Y direction.

Then, the manufacturing device 1 further moves the carriage 12 in the Y2 direction in a state where buoyancy acts on the overhang regions W1 and W1, and thus flattens the color portion 71′ by the roller unit 3 and cures the color portion 71′ by the ultraviolet irradiation unit 4. Thus, the color portion 71 formed of the cured ink is formed as the ink layer L2.

As illustrated in FIG. 6B, the color portion 71 after curing sinks toward the lower side in the Z direction by its own weight in a state where the positions in the X and Y directions are retained (in the drawing, the white arrow). In this case, the color portion 71 and the ejection table 72 are balanced with the buoyancy F at a position where an upper surface 71a is flush with the liquid surface 60. The ink layer L1 and the ink layer L2 are layered in the liquid 6 while being kept horizontal (layering step).

Then, the liquid 61 overflows from the space Ra of the liquid storage 5 by the volume by which the ink layer L2 (color portion 71) sinks in the liquid 6. Thus, the liquid surface 60 of the liquid 6 is maintained to be flush with the upper surface 51a of the first peripheral wall portion 51 of the liquid storage 5.

### Formation of Ink Layer L3

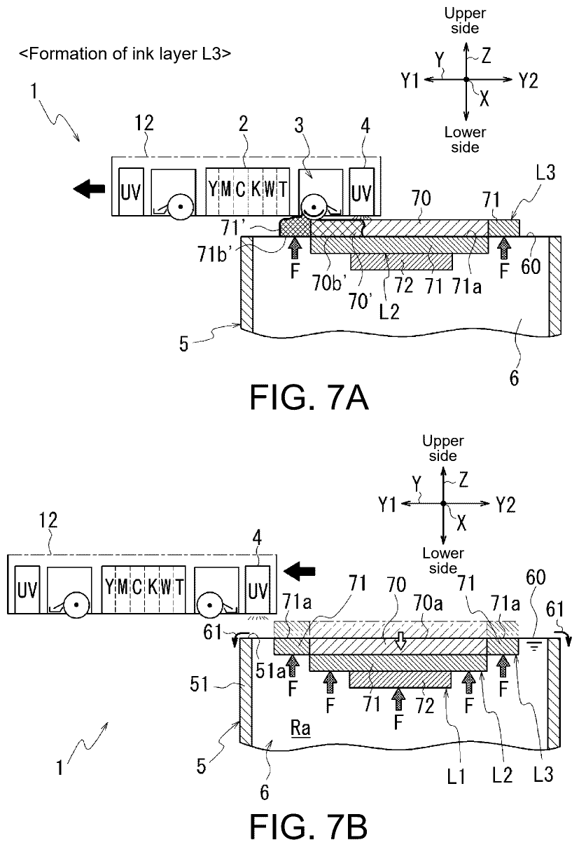

FIG. 7A and FIG. 7B are views illustrating the formation of the ink layer L3. FIG. 7A is a view illustrating the ejection of the ink. FIG. 7B is a view illustrating the ink layer L3.

As illustrated in FIG. 7A, the manufacturing device 1 ejects the ink from the head unit 2 toward the liquid 6 while moving the carriage 12 in the Y1 direction (in the drawing, the black arrow).

As illustrated in FIG. 4B, the ink layer L3 has a larger area than the ink layer L2, and is provided in a range crossing the ink layer L2 in the Y direction. Specifically, the solid portion 70 of the ink layer L3 has an area substantially matching a color portion 71 of the ink layer L2. The color portion 71 of the ink layer L3 is provided on the outer periphery of the solid portion 70, and projects in the Y direction from the color portion 71 of the ink layer L2.

Therefore, as illustrated in FIG. 7A, the ink ejected from the head unit 2 lands in a range across the upper surface 71a of the color portion 71 of the ink layer L2 and the liquid surface 60 of the liquid 6. Therefore, the color portion 71′ overhangs in the Y direction than the color portion 71 of the ink layer L2. The lower surface 71b′ of the color portion 71′ is in contact with the liquid surface 60 of the liquid 6. A lower surface 70b′ of a solid portion 70′ is in contact with the upper surface 71a of the color portion 71 of the ink layer L2.

The buoyancy Facts on the lower surface 71b′ of the color portion 71′ from the liquid 6 (in the drawing, the hatched arrow). The lower surface 70b′ of the solid portion 70′ is supported by the color portion 71 of the ink layer L2. Therefore, the solid portion 70′ and the color portion 71′ are maintained in a state parallel to the liquid surface 60 over the entire length in the Y direction.

Then, the manufacturing device 1 further moves the carriage 12 in the Y2 direction, and thus flattens the solid portion 70′ and the color portion 71′ by the roller unit 3 and cures the solid portion 70′ and the color portion 71′ by the ultraviolet irradiation unit 4. Thus, the solid portion 70 and the color portion 71 formed of the cured ink are formed as the ink layer L3.

As illustrated in FIG. 7B, the solid portion 70 and the color portion 71 after curing sink toward the lower side in the Z direction by their own weight in a state where the positions in the X and Y directions are maintained (in the drawing, the white arrow). In this case, the solid portion 70 and the color portion 71 are balanced with the buoyancy F at a position where the upper surfaces 70a and 71a are flush with the liquid surface 60. The ink layers L1 to L3 are layered in the liquid 6 while being kept horizontal.

Then, the liquid 61 overflows from the space Ra of the liquid storage 5 by the volume by which the ink layer L3 (the solid portion 70 and the color portion 71) sinks in the liquid 6. Thus, the liquid surface 60 of the liquid 6 is maintained to be flush with the upper surface 51a of the first peripheral wall portion 51 of the liquid storage 5.

In the same manner, the ejecting step of ejecting the ink from the head unit 2 toward the liquid 6, the flattening step of flattening the ink by the roller unit 3, and the curing step of curing the ink by the ultraviolet irradiation unit 4 are repeated to form the ink layers L4 to Ln. Thus, the ink layers are sequentially layered in the liquid 6 to manufacture the shaped object 7 (see FIG. 4B).

As such, in the manufacturing method of the shaped object 7 according to the present embodiment, the buoyancy of the liquid 6 can be used instead of the support material by ejecting the ink toward the liquid 6.

Here, in a case where the shaped object 7 is manufactured using a conventional support material, the ink for the support material and the ink for the color portion 71 are mixed at the interface before the ink is cured. Thus, the surface of the color portion 71 may become rough, and the quality and shaping accuracy of the surface of the shaped object 7 may deteriorate.

On the other hand, in the manufacturing method of the shaped object 7 according to the present embodiment, the surface of the color portion 71 of the shaped object 7 is in contact with the liquid 6 (see FIG. 4B). As described above, the liquid 6 contains polyvinyl alcohol (PVA), borax, and water. Therefore, the liquid 6 is hardly mixed at the interface with the color portion 71. Therefore, the quality and the shaping accuracy of the surface of the color portion 71 are less likely to be affected than in the case of using the conventional support material.

Therefore, fine color expression and fine shaping expression of the shaped object, which are advantages of the inkjet method, can be utilized.

As described above, the manufacturing device 1 of the shaped object 7 according to the present embodiment has the following configuration.
(1) The shaped-object manufacturing device 1 shapes the three-dimensional shaped object 7.

The manufacturing device 1 includes: the liquid storage 5 that retains the liquid 6;
the head unit 2 (ejector) that ejects the ink to the liquid 6; and
the roller 301 that comes into contact with the ink retained by the liquid surface 60 of the liquid 6.

With this configuration, for example, as illustrated in FIG. 6A, in the ink (color portion 71′) retained by the liquid surface 60, the buoyancy F from the liquid 6 acts on the overhang regions W1, W1. In this state, an ink 71′ is flattened over the entire surface by coming into contact with the roller 301. Therefore, the ink constituting the overhang regions W1 and W1 of the color portion 71′ can be flattened in the ink layer L2 without using the support material. The same applies to the ink layers L3 to Ln.
(2) The roller 301 is provided to be relatively movable with respect to the liquid storage 5.

When viewed from the liquid storage 5, the roller 301 rotates so that a portion in contact with the ink is oriented in a direction of the relative movement.

According to such a configuration, for example, as illustrated in the enlarged region of FIG. 5A, the smoothness of the ink of the portion in contact with the roller 301, such as the upper surface 72a′ of the ejection table 72′, is improved.
(3) The roller 301 is provided to be relatively movable with respect to the liquid storage 5.

When viewed from the liquid storage 5, the roller 301 rotates so that a portion in contact with the ink is oriented in a direction opposite to the direction of the relative movement.

According to such a configuration, for example, as illustrated in the enlarged region of FIG. 5A, mixing of the ink is small at the portion in contact with the roller 301, such as the upper surface 72a′ of the ejection table 72′.
(4) The roller unit 3 including the roller 301 includes the adjustment portion 31 (adjustment mechanism) that adjusts the contact pressure between the roller 301 and the ink.

According to such a configuration, the position of the ink on the liquid surface 60 can be reduced from being displaced by being pushed by the contact with the roller 301.
(5) The manufacturing device 1 includes the ultraviolet irradiation unit 4 (curing unit) that irradiates the ink with ultraviolet UV rays to cure the ink.

According to such a configuration, the flattened ink can be sequentially layered.
(6) The head unit 2 can be an inkjet head.

According to such a configuration, fine color expression and fine shaping can be performed by ejecting the ink from the inkjet head.

The manufacturing method of the shaped object 7 according to the present embodiment includes the following steps.
(7) In the shaped-object manufacturing method, a three-dimensional shaped object 7 is shaped.

The manufacturing method of the shaped object 7 includes:
the ejecting step of ejecting the ink to the liquid 6 stored in the liquid storage 5;
the flattening step of flattening the ink retained by the liquid surface 60 of the liquid 6 by the roller 301; and
the curing step of curing the flattened ink with ultraviolet UV rays to form the ink layers L1 to Ln.

When manufactured in this manner, for example, as illustrated in FIG. 6A, the overhang regions W1 and W1 in the color portion 71′ retained by the liquid surface 60 are flattened by the roller 301 in a state where buoyancy acts from the liquid 6, and are cured by the ultraviolet irradiation unit 4. Therefore, the ink constituting the overhang regions W1 and W1 of the color portion 71′ can be flattened and cured in the ink layer L2 without using the support material. By repeating these steps up to the ink layer Ln, stable shaping can be performed without using the support material.
(8) The roller 301 is moved relative to the liquid storage 5.

When viewed from the liquid storage 5, the roller 301 is rotated so that a portion in contact with the ink is oriented in a direction of the relative movement.

When manufactured in this manner, for example, as illustrated in the enlarged region of FIG. 5A, the smoothness of the ink of the portion in contact with the roller 301, such as the upper surface 72a′ of the ejection table 72′, is improved.
(9) The roller 301 is moved relative to the liquid storage 5.

When viewed from the liquid storage 5, the roller 301 is rotated so that a portion in contact with the ink is oriented in a direction opposite to the direction of the relative movement.

When manufactured in this manner, for example, as illustrated in the enlarged region of FIG. 5A, mixing of the ink is small at the portion in contact with the roller 301, such as the upper surface 72a′ of the ejection table 72′.
(10) The manufacturing method includes the adjustment step of adjusting the contact pressure between the roller 301 and the ink.

When manufactured in this manner, it is possible to reduce the displacement of the position of the ink on the liquid surface 60 by being pushed by the contact with the roller 301.
(11) The method for ejecting the ink can be an inkjet method.

When manufactured in this manner, since the surface of the shaped object is not affected by the support material, fine color expression and fine shaping expression, which are advantages of the inkjet method, can be utilized.

Note that, in the present embodiment, the case where the ejecting step, the flattening step, and the curing step are performed in one pass is exemplified, but the present invention is not limited thereto. These steps may be divided into a plurality of passes. For example, the first pass may be the ejecting step, the second pass may be the flattening step, and the third pass may be the curing step.

In addition, in the present embodiment, the ejection table 72 is formed to secure the horizontal prior to the shaping of the shaped object 7, but the present invention is not limited to this mode. For example, prior to the shaping of the shaped object 7, the liquid surface 60 of the liquid 6 may be flattened by the roller unit 3 to ensure the horizontal. In this case, the color portion 71 (see FIG. 4B) of the ink layer L2 can be directly formed on the liquid surface 60 that is horizontal without forming the ejection table 72. In addition, a roller or a scraper different from the roller unit 3 may be provided in the carriage 12, and the liquid surface 60 of the liquid 6 may be horizontal by the roller or the scraper.

As illustrated in FIG. 5A, in the present embodiment, the method of adjusting the bite amount Δh by changing the protrusion amount ha of the roller portion 30 in the flattening by the roller unit 3 is exemplified, but the present invention is not limited to this mode. The bite amount Δh may be adjusted by adjusting the ejection amount of the ink on the head unit 2 side. In this case, a thickness of the ink layer formed on the lower side is measured with a laser or light, and the ejection amount of the ink is adjusted based on the measurement result. Alternatively, the protrusion amount ha and the rotation speed of the roller 301 may be adjusted using AI and machine learning. For example, the cross-sectional area (slice data) of the shaped object 7, the material of the shaped object 7, the physical properties of the ink, the physical properties (viscosity, thixotropy, and specific gravity) of the liquid 6, and the like are learned.

In addition, in the present embodiment, the liquid 6 having a predetermined viscosity contains polyvinyl alcohol (PVA), borax, and water, but the present invention is not limited to this mode. The liquid 6 may have a predetermined viscosity by containing a material exhibiting thixotropy. For example, the liquid 6 may be a mixture of water, flour, soybean flour, and starch, or a mixture of a resin material (a monomer or an oligomer) and a filler.

In addition, by imparting adhesiveness to the liquid 6, the ink landed on the liquid surface 60 of the liquid 6 may not move in the X and Y directions. As a method for imparting adhesiveness, adhesiveness may be imparted by dissolving an adhesive material in a volatile solvent (alcohol, water, acetone, or the like) and volatilizing the solvent by heat (reaction heat between the ink and the liquid 6, exhaust heat of the manufacturing device 1, a heating and cooling device 9 described below, or the like) at the time of shaping. Alternatively, an adhesive material that reacts with ultraviolet rays may be placed in the liquid 6 and irradiated with ultraviolet UV rays to impart adhesiveness. Alternatively, adhesiveness may be imparted using a mixture of natural rubber and a petroleum resin, or a mixture of an acrylic, urethane, or silicone-based resin to adjust the molecular weight and crosslinking density.

### Modification 1

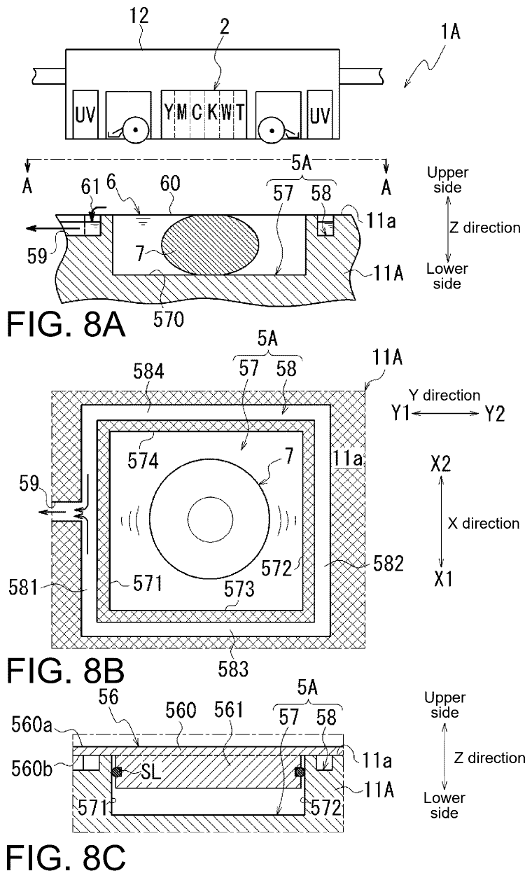

In the embodiment described above, the case where the liquid storage 5 is placed on the table 11 as a separate component is exemplified, but the present invention is not limited to this mode. For example, as illustrated in FIG. 8A, FIG. 8B, and FIG. 8C, a manufacturing device 1A may be configured so that a table 11A itself is provided with a liquid storage 5A. In Modification 1, only portions different from those in the embodiment described above will be described.

FIG. 8A, FIG. 8B, and FIG. 8C are views illustrating the manufacturing device 1A according to Modification 1. FIG. 8A is a schematic configuration view of the manufacturing device 1A. FIG. 8B is a view illustrating a liquid storage 5A. FIG. 8B is a view taken along the line A-A in FIG. 8A. FIG. 8C is a view illustrating another use mode of the manufacturing device 1A.

As illustrated in FIG. 8A, the liquid storage 5A includes a recess 57 that opens in an upper surface 11a of the table 11A, and a recessed groove 58 that surrounds an outer periphery of the recess 57. The recess 57 and the recessed groove 58 are recessed toward in the lower side in the Z direction from the upper surface 11a of the table 11. A bottom surface 570 of the recess 57 is a flat surface parallel to the upper surface 11a of the table 11. The inside of the recess 57 is filled with the liquid 6. In the recess 57, the shaped object 7 is immersed in the liquid 6.

As illustrated in FIG. 8B, the recess 57 has a rectangular shape in plan view.

The recess 57 includes wall portions 571 and 572 provided in a direction along the X direction and wall portions 573 and 574 provided in a direction along the Y direction and connecting end portions of the wall portions 571 and 572.

The recessed groove 58 includes grooves 581 and 582 provided in a direction along the X direction and grooves 583 and 584 provided in a direction along the Y direction and connecting end portions of the grooves 581 and 582. The grooves 581 to 584 of the recessed groove 58 are provided in parallel to the wall portions 571 to 574 of the recess 57.

As illustrated in FIG. 8B, the groove 571 of the recessed groove 58 is connected with a discharge groove 59 extending in a direction away from the recess 57 in the Y direction. The liquid 6 overflowing from the inside of the recess 57 passes through the grooves 581 to 584 and is discharged from the discharge groove 59 to the outside.

Here, the liquid storage 5A is directly formed on the table 11A. Therefore, the positions in the X and Y directions are fixed. Thus, as in the embodiment described above, it is not necessary to provide the positioning pins Px and Py on the table 11 to perform the positioning operation of the liquid storage 5 (see FIG. 2). Therefore, the set-up work in the manufacturing of the shaped object 7 can be reduced.

When manufacturing the shaped object 7 using the manufacturing device 1A, the ink is ejected from the head unit 2 to the liquid surface 60 of the liquid 6 in a state where the recess 57 is filled with the liquid 6 in advance. Then, the ejecting step and the curing step are repeated to shape the shaped object 7.

As illustrated in FIG. 8A, the overflowing liquid 61 is collected in the recessed groove 58 and the discharge groove 59. Thus, the shaped object 7 can be manufactured by the manufacturing device 1A including the liquid storage 5A.

Here, as illustrated in FIG. 8B, the manufacturing device 1A according to Modification 1 may include a cover 56 that closes an opening of the liquid storage 5A.

The cover 56 includes a plate portion 560 that covers the entire upper surface 11a of the table 11A, and a thick portion 561 that protrudes from the other surface 560b in a thickness direction of the plate portion 560.

One surface 560a and the other surface 560b in the thickness direction of the plate portion 560 are flat surfaces parallel to each other.

The thick portion 56 has a rectangular shape in plan view. The thick portion 561 has an area slightly smaller than an area of a region surrounded by the wall portions 571 to 574 (see FIG. 8B) of the recess 57. On an outer periphery of the thick portion 561, a sealing material SL is provided over the entire periphery.

When the liquid storage 5A is closed by the cover 56, the thick portion 561 is inserted into the recess 57 and pushed until the other surface 560b of the plate portion 560 is in contact with the upper surface 11a of the table 11A. Thus, the opening of the liquid storage 5A is closed by the cover 56. In this case, one surface 560a of the plate portion 560 is a surface facing the head unit 2 (see FIG. 8A). Thus, the cover 56 also functions as a conventional shaping table. Since the sealing material SL is interposed between the thick portion 561 and the recess 57, the cover 56 can also be reduced in rattling during the shaping.

### Modification 2

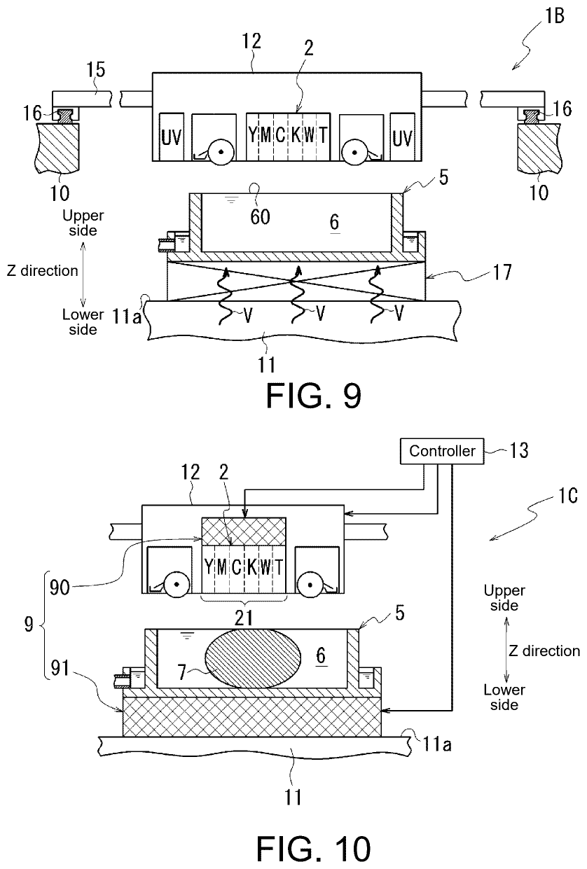

FIG. 9 is a view illustrating a manufacturing device 1B according to Modification 2.

As illustrated in FIG. 9, the guide rails 15 and 16 and the body frame 10 that support the carriage 12 vibrate by receiving an inertial force of the carriage 12 when the carriage 12 is accelerated and decelerated in the X and Y directions. The vibration V is propagated to the table 11, and finally vibrates the liquid surface 60 of the liquid 6 and the shaped object 7 in the liquid storage 5. When the liquid surface 60 of the liquid 6 and the shaped object 7 in the liquid storage 5 vibrate, the landing position of the ink may shift. In addition, due to the vibration, the shaped object 7 may move in the liquid storage 5. Therefore, the manufacturing device 1B according to Modification 2 includes a vibration suppression mechanism 17 that damps the vibration V.

As illustrated in FIG. 9, in the manufacturing device 1B according to Modification 2, the vibration suppression mechanism 17 is provided between the liquid storage 5 and the upper surface 11a of the table 11A in the Z direction.

The vibration suppression mechanism 17 may be any mechanism as long as it can damp the vibration V, and examples thereof include a vibration-proof rubber, an air spring, a coil spring, and a damper mechanism.

Thus, even when the table 11 vibrates due to acceleration and deceleration of the carriage 12, the vibration V of the table 11 is damped before being propagated to the liquid storage 5 and the liquid 6 by the vibration suppression mechanism 17. Therefore, the liquid surface 60 of the liquid 6 and the shaped object 7 in the liquid storage 5 are shaken, and the landing position of the ink can be reduced from shifting. In addition, the shaped object 7 can be reduced from moving in the liquid storage 5.

Note that, in the manufacturing device 1B according to Modification 2, the vibration suppression mechanism 17 provided between the table 11 and the liquid storage 5 is exemplified, but the present invention is not limited to this mode. For example, the table 11 itself may have a function of suppressing the vibration V.

### Modification 3

In the embodiment described above, the manufacturing device 1 that radiates ultraviolet UV rays from the ultraviolet irradiation unit 4 is exemplified, but the present invention is not limited to this mode. For example, a manufacturing device 1C that heats and cools the ink or the liquid 6 by the heating and cooling device 9 may be used. In Modification 3, only portions different from those in the embodiment described above will be described.

FIG. 10 is a view illustrating the manufacturing device 1C according to Modification 3. In FIG. 10, a region where the heating and cooling device 9 is provided is cross-hatched.

As illustrated in FIG. 10, the manufacturing device 1C includes the heating and cooling device 9 instead of the ultraviolet irradiation unit 4 of the embodiment described above. Examples of the heating and cooling device 9 include a device that performs heating and cooling using a Peltier device.

The heating and cooling device 9 includes a first heating and cooling unit 90 and a second heating and cooling unit 91. The first heating and cooling unit 90 is provided in the head unit 2 and heats and cools the ink in the heads 21 (21Y to 21T). The second heating and cooling unit 91 is provided between the table 11 and the liquid storage 5, and heats and cools the liquid 6.

For example, when manufacturing the shaped object 7 using a thermosetting ink, only the second heating and cooling unit 91 is driven to heat the liquid 6. The ink in the head 21 is at room temperature. Therefore, the temperature of the liquid 6 is higher than the temperature of the ink in the head 21.

When the ink is ejected from the head unit 2 toward the liquid 6, the ink landed on the liquid surface 60 is heated and cured by the liquid 6. The cured ink sinks in the liquid 6. By repeating the operation, the ink layers L1 to Ln are layered in the liquid 6, and the shaped object 7 is manufactured. By using the thermosetting ink, the shaped object 7 having high heat resistance can be manufactured.

In addition, when manufacturing the shaped object 7 using the thermoplastic ink, the first heating and cooling unit 90 is driven to heat the ink in the head 21, and the second heating and cooling unit 91 is driven to cool the liquid 6. Therefore, the temperature of the ink in the head 21 is higher than the temperature of the liquid 6.

When the ink is ejected from the head unit 2 toward the liquid 6, the ink landed on the liquid surface 60 is cooled and cured by the liquid 6. The cured ink sinks in the liquid 6. By repeating the operation, the ink layers LI to Ln are layered in the liquid 6, and the shaped object 7 is manufactured. Since the thermoplastic ink has a high viscosity, the thermoplastic ink can be stably ejected, and spreading of the ink in the liquid 6 can be reduced.

### Modification 4

In the embodiment and Modifications 1 to 3 described above, the liquid storage 5 is disposed in advance on the table 11, and the shaping is performed in a state where the inside of the liquid storage 5 is filled with the liquid 6, but the present invention is not limited to this mode. In Modification 4, an example in which the shaping of the shaped object 7 is performed in parallel while shaping a liquid storage 5B with the ink on the table 11 will be described. In Modification 4, only portions different from those in the embodiment described above will be described.

FIG. 11 is a view illustrating a manufacturing device 1D according to Modification 4. In FIG. 11, the shaped object 7 manufactured by the manufacturing device 1D and the liquid storage 5B are indicated by virtual lines.

FIG. 12 is a view illustrating slice data of the shaped object 7 including the liquid storage 5B.

Note that, in the liquid storage 5B according to Modification 4, a liquid storage not including the second peripheral wall portion 52 described above will be exemplified.

In the manufacturing device 1D according to Modification 4, a coupling arm 114 extending in the Z direction is connected to one side of the table 11. A coupling section 115 provided on an upper portion of the coupling arm 12 is connected to the guide rail 116 disposed along the vertical line VL parallel to the Z direction.

In this state, the coupling section 115 is provided to be movable along the Z direction of the guide rail 116. When a drive mechanism (not illustrated) provided inside the coupling section 115 operates based on a command from the controller 13, the table 11 connected to the coupling section 115 via the coupling arm 114 moves in the vertical direction (in the drawing, the white arrow).

As illustrated in FIG. 11, the manufacturing device 1D includes the supplying unit 8 that supplies the liquid 6 into the liquid storage 5B. The supplying unit 8 includes a tank 80 that stores the liquid 6 and a hose 81 provided across the tank 80 and the liquid storage 5B. Although not illustrated, the supplying unit 8 includes a moving mechanism that moves the tank 80 and the hose 81 in the Y direction and the Z direction. In addition, although not illustrated, the hose 81 is provided with a valve for switching between flowing and blocking of the liquid 6 from the tank 80. The moving mechanism and the valve are controlled by the controller 13.

When the liquid 6 is supplied into the liquid storage 5B, the supplying unit 8 moves the tank 80 to a position offset upward from the liquid surface 60 of the liquid storage 5B based on a command from the controller 13. Thus, the liquid 6 moves by a predetermined amount from the tank 80 side toward the liquid storage 5B by the principle of siphoning. In addition, when shaping the liquid storage 5B with the ink, the supplying unit 8 moves in the Y direction to avoid interference with the carriage 12.

Note that the moving mechanism may move the tank 80 and the hose 81 in the X direction to avoid interference with the carriage 12.

As illustrated in FIG. 12, in the manufacturing device 1D, the shaped object 7 and the liquid storage 5B are sliced (partitioned) at equal intervals in the Z direction, and N ink layers (L1 to Ln: n is an arbitrary integer) are set.

In the ink layer L1, a bottom wall portion 50 of the liquid storage 5B is formed instead of the ejection table 72 described above (see FIG. 4B). The color portion 71 and the first peripheral wall portion 51 are formed on the ink layers L2 and Ln. The solid portion 70, the color portion 71, and the first peripheral wall portion 51 are formed in the ink layer L3 to the ink layer Ln−1. That is, the ink layers corresponding to the shaped object 7 are the ink layers L2 to Ln. For example, a white (W) ink can be used for forming the bottom wall portion 50 and the first peripheral wall portion 51.

Hereinafter, a manufacturing method of a shaped object 7 using the manufacturing device 1D according to Modification 4 will be described.

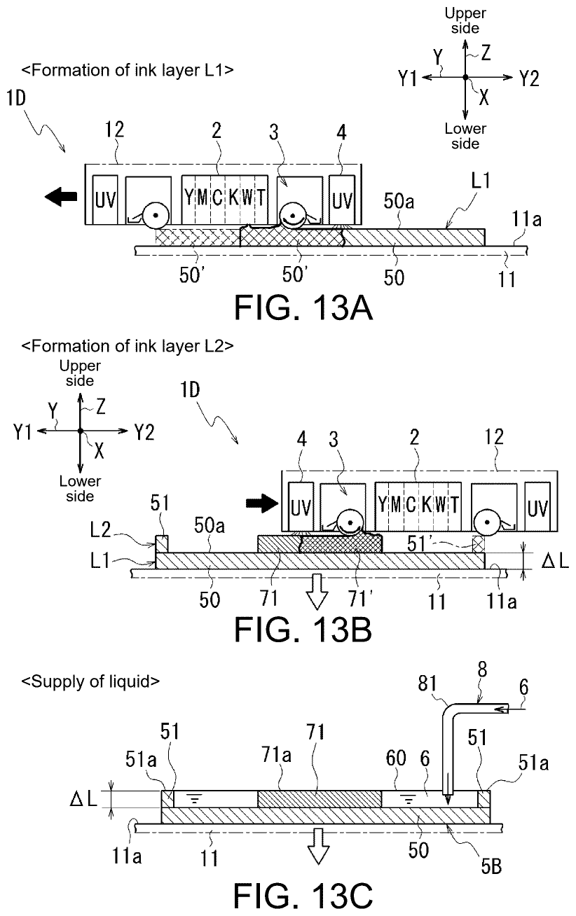

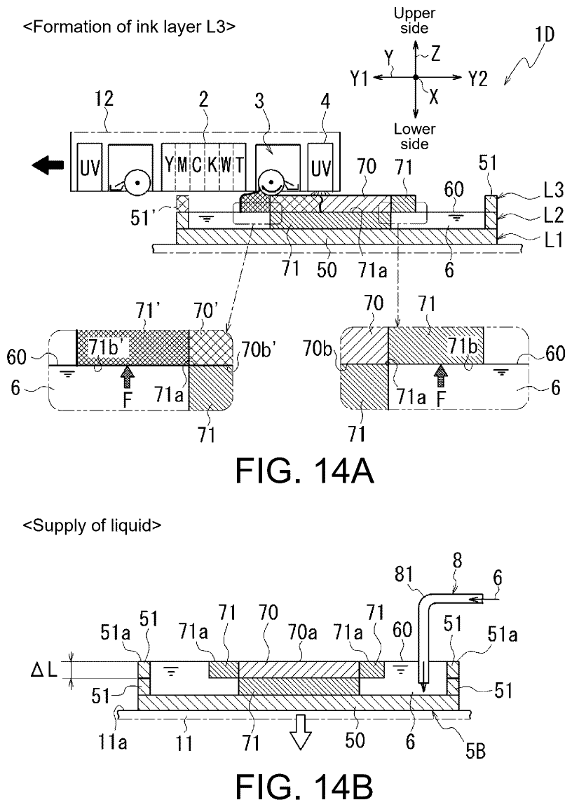

FIGS. 13A to 14B are views sequentially illustrating the manufacturing of the liquid storage 5B and the shaped object 7.

FIG. 13A, FIG. 13B, and FIG. 13C are views illustrating the manufacturing of the shaped object 7 according to Modification 4. FIG. 13A is a view illustrating the formation of the ink layer L1. FIG. 13B is a view illustrating the formation of the ink layer L2. FIG. 13C is a view illustrating the supply of the liquid 6.

FIG. 14A and FIG. 14B are views illustrating the manufacturing of the shaped object 7 according to Modification 4. FIG. 14A is a view illustrating the formation of the ink layer L3. FIG. 14B is a view illustrating the supply of the liquid 6.

### Formation of Ink Layer L1

As illustrated in FIG. 13A, the manufacturing device 1D ejects the ink from the head unit 2 toward the upper surface 11a of the table 11 while moving the carriage 12 in the Y1 direction (in the drawing, the black arrow). In addition, the manufacturing device 1D flattens a bottom wall portion 50′ by the roller unit 3 and cures the bottom wall portion 50′ by the ultraviolet irradiation unit 4 while moving the carriage 12 in the Y1 direction. Thus, the bottom wall portion 50 is formed as the ink layer L1. An upper surface 50a of the bottom wall portion 50 is a horizontal plane along the X and Y directions.

### Formation of Ink Layer L2

As illustrated in FIG. 13B, when the formation of the bottom wall portion 50 is completed, the table 11 is offset downward in the Z direction by a thickness ΔL of the ink layer L1 along the guide rail 116 (see FIG. 11) (the white arrow in FIG. 13B).

Next, the manufacturing device 1D ejects the ink from the head unit 2 toward the upper surface 50a of the bottom wall portion 50 while moving the carriage 12 in the Y2 direction (in the drawing, the black arrow). Specifically, the head unit 2 ejects the ink to be a first peripheral wall portion 50′ to both ends of the bottom wall portion 51 in the Y direction, and ejects the ink to be the color portion 71′ to a substantially intermediate position of the bottom wall portion 50 in the Y direction.

In addition, the manufacturing device 1D flattens the first peripheral wall portion 51′ and the color portion 71′ by the roller unit 3 and cures the first peripheral wall portion 51′ and the color portion 71′ by the ultraviolet irradiation unit 4 while moving the carriage 12 in the Y2 direction. Thus, the first peripheral wall portions 51 and 51 and the color portion 71 are formed as the ink layer L2 on the upper surface 50a of the bottom wall portion 50. A part of the liquid storage 5B is formed by forming the bottom wall portion 50 and a part of the first peripheral wall portions 51 and 51.

Note that, when forming the ink layers L1 and L2, the supplying unit 8 is retracted while avoiding interference with the carriage 12. In addition, the valve of the hose 81 is closed to block the flow of the liquid 6 from the tank 80.

### Supply of Liquid 6

As illustrated in FIG. 13C, the supplying unit 8 moves above the liquid storage 5B and supplies the liquid 6 into the liquid storage 5B by opening the valve of the hose 81. The supplying unit 8 supplies the liquid 6 having the same height as a thickness ΔL of the ink layer L2 by offsetting the tank 80 (see FIG. 11) to the upper side in the Z direction by a predetermined amount (supplying step). The offset amount of the tank 80 can be set in advance by the controller 13 or the like.

Thus, the upper surface 51a of the first peripheral wall portion 51, the upper surface 71a of the color portion 71, and the liquid surface 60 of the liquid 6 in the ink layer L2 are flush with each other.

Note that, after the liquid 6 is supplied, the carriage 12 may be further moved in the Y1 direction to flatten the liquid surface 60 by the roller unit 3. Thus, it is possible to cope with a case where there is a variation in the supply amount of the liquid 6 by the supplying unit 8.

When the supply of the liquid 6 is completed, the table 11 is offset downward in the Z direction by the thickness ΔL of the ink layer L2 along the guide rail 116 (see FIG. 11) (the white arrow in FIG. 13C). In addition, after blocking the valve of the hose 81, the supplying unit 8 moves upward and retracts to avoid interference with the first peripheral wall portion 51, and then moves in the Y direction and retracts to avoid interference with the carriage 12.

### Formation of Ink Layer L3

As illustrated in FIG. 14A, the manufacturing device 1D ejects the ink from the head unit 2 toward the first peripheral wall portion 51 and the color portion 71 of the ink layer L2 while moving the carriage 12 in the Y1 direction (in the drawing, the black arrow).

As illustrated in FIG. 14A, the color portion 71 of the ink layer L3 projects in the Y direction from the color portion 71 of the ink layer L2.

Therefore, in the ink layer L3, among the inks ejected from the head unit 2, the ink constituting the color portion 71′ is overhung and layered from the ink layer L2. In addition, among the inks ejected from the head unit 2, the ink constituting the first peripheral wall portion 51′ is layered from the ink layer L2 without overhanging.

As illustrated in the enlarged region of FIG. 14A, the lower surface 71b′ of the color portion 71′ is in contact with the liquid surface 60 of the liquid 6. A lower surface 70b′ of a solid portion 70′ is in contact with the upper surface 71a of the color portion 71 of the ink layer L2.

The buoyancy F acts on the lower surface 71b′ of the color portion 71′ from the liquid 6 (in the drawing, the hatched arrow). The lower surface 70b′ of the solid portion 70′ is supported by the color portion 71 of the ink layer L2. Therefore, the solid portion 70′ and the color portion 71′ are maintained in a state parallel to the liquid surface 60 over the entire length in the Y direction.

Then, the manufacturing device 1D further moves the carriage 12 in the Y1 direction to perform flattening by the roller unit 3 and curing by the ultraviolet irradiation unit 4. Thus, the first peripheral wall portions 51 and 51, the solid portion 70, and the color portion 71 are formed as the ink layer L3.

### Supply of Liquid 6

As illustrated in FIG. 14B, the supplying unit 8 moves above the liquid storage 5B and supplies the liquid 6 into the liquid storage 5B by opening the valve of the hose 81. The supplying unit 8 supplies the liquid 6 having the same height as a thickness ΔL of the ink layer L3. Thus, the upper surface 51a of the first peripheral wall portion 51, the upper surface 70a of the solid portion 70, the upper surface 71a of the color portion 71, and the liquid surface 60 of the liquid 6 in the ink layer L3 are flush with each other.

When the supply of the liquid 6 is completed, the table 11 is offset downward in the Z direction by the thickness ΔL of the ink layer L3 along the guide rail 116 (see FIG. 11) (the white arrow in FIG. 14B).

In the same manner, the ejecting step of ejecting the ink from the head unit 2 toward the liquid 6, the flattening step of flattening the ink by the roller unit 3, the curing step of curing the ink by the ultraviolet irradiation unit 4, and the supplying step of supplying the liquid 6 are repeated to form the ink layers L4 to Ln. Thus, the ink layers are sequentially layered to manufacture the liquid storage 5B and the shaped object 7 (see FIG. 12).

Note that, since the shaped object 7 does not have the overhang region above the horizontal line HL passing through the center C of the shaped object 7, the shaping of the first peripheral wall portion 51 and the supply of the liquid 6 may be up to the region constituting the ink layer La in the Z direction. The shape can be appropriately changed according to the shape of the shaped object 7.

Thus, it is not necessary to prepare the liquid storage 5 and the liquid 6 in advance as in the embodiment described above, and the shaped object 7 can be substantially automatically manufactured by reducing the set-up work.

### Modification 5

In the embodiment and Modification 3 described above, a method of applying energy from the outside to cure the ink, such as irradiation with ultraviolet UV rays by the ultraviolet irradiation unit 4 (see FIG. 5A and FIG. 5B) and heating of the ink or the liquid 6 by the heating and cooling device 9 (see FIG. 10) are exemplified, but the present invention is not limited to this mode. For example, an ink containing a material serving as a main agent and a liquid 6A containing a material serving as a curing agent are used, and the ink may be mixed with the liquid 6A to be naturally cured. Furthermore, various performances can be added to the shaped object 7 by changing the combination of the material serving as the main agent and the material serving as the curing agent.

In the following description, a case where an ink formed of an epoxy resin and a liquid 6A formed of an amine-based curing agent are used will be described as an example.

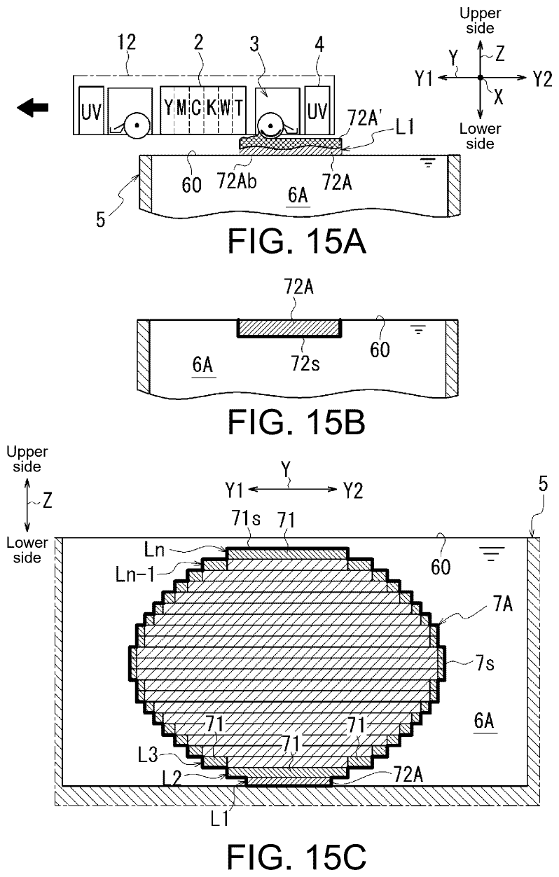

FIG. 15A, FIG. 15B, and FIG. 15C are views illustrating a manufacturing of a shaped object 7A according to Modification 5. FIG. 15A is a view illustrating the formation of the ink layer L1. FIG. 15B is a view illustrating the ink layer L1 in the liquid 6A. FIG. 15C is a view illustrating the shaped object 7A.

As illustrated in FIG. 15A, in a case where an ejection table 72A constituting the ink layer L1 is formed, the ink is ejected from the head unit 2 toward the liquid 6A while moving the carriage 12 in the Y1 direction (in the drawing, the black arrow direction). An ejection table 72A′ including an uncured ink floats on a liquid surface 60 of the liquid 6A.

The ejection table 72A′ is in contact with the liquid 6. Therefore, the ejection table 72A′ is cured from a lower surface 72Ab side serving as an interface. The ejection table 72A′ is flattened by the roller unit 3 while being cured on the lower surface 72Ab side.

As illustrated in FIG. 15B, the cured ejection table 72A sinks in the liquid 6A.

Here, the ink is an epoxy resin, and the liquid 6A is an amine-based curing agent. Therefore, in the cured ejection table 72, in particular, a surface 72s that is a portion in contact with the liquid 6A has high hardness. Furthermore, by sequentially layering the ink layers L2 to Ln, the hardness of the surface 7s in contact with the liquid 6A is increased in the shaped object 7A (see FIG. 15C). Thus, the shaped object 7A having high corrosion resistance and scratch resistance can be manufactured.

Note that, in order to cure the surface 71s of the color portion 71 constituting the ink layer Ln, a depth of the liquid storage 5 may be set to a depth at which the shaped object 7A can be submerged in the liquid 6A.

### Other Modifications

Hereinafter, other modifications will be described with reference to FIG. 15A, FIG. 15B, and FIG. 15C.

The combination of the material serving as the main agent and the material serving as the curing agent is not limited to the epoxy resin and the amine-based curing agent.

For example, the ink may contain a metal catalyst component, and the liquid 6A may contain a peroxide component. Thus, the shaped object 7A formed of an acrylic resin is manufactured. By using the acrylic resin, the shaped object 7A having high transparency can be manufactured.

In addition, the ink may contain a platinum catalyst component, and the liquid 6A may be a crosslinking agent having a hydrosilyl group. Thus, the shaped object 7A formed of a silicone-based resin is manufactured. The silicone-based resin is highly safe to a human body. In addition, the surface 7s of the shaped object 7A becomes soft, and a tactile sensation can be provided.

In addition, the ink may contain a photoinitiator, and the liquid 6A may have a reactive group. In this case, the ultraviolet irradiation unit 4 irradiates the liquid surface 60 of the liquid 6A with the ultraviolet UV rays in a state where the ink is landed on the liquid surface 60 of the liquid 6A. Then, the ink is cured from the interface side between the ink and the liquid 6A. A curing speed at this time is faster than the case of using the epoxy-based resin, the acrylic resin, and the silicone-based resin described above. Therefore, a manufacturing time of the shaped object 7A can be shortened.

### Modification 6

In addition, the shaped-object manufacturing method and manufacturing device according to the present invention can also be applied to manufacturing of a shaped object 7B having a more complicated shape than the exemplified shaped object 7. Hereinafter, as Modification 6, a case of manufacturing a humanoid shaped object 7B will be described as an example.

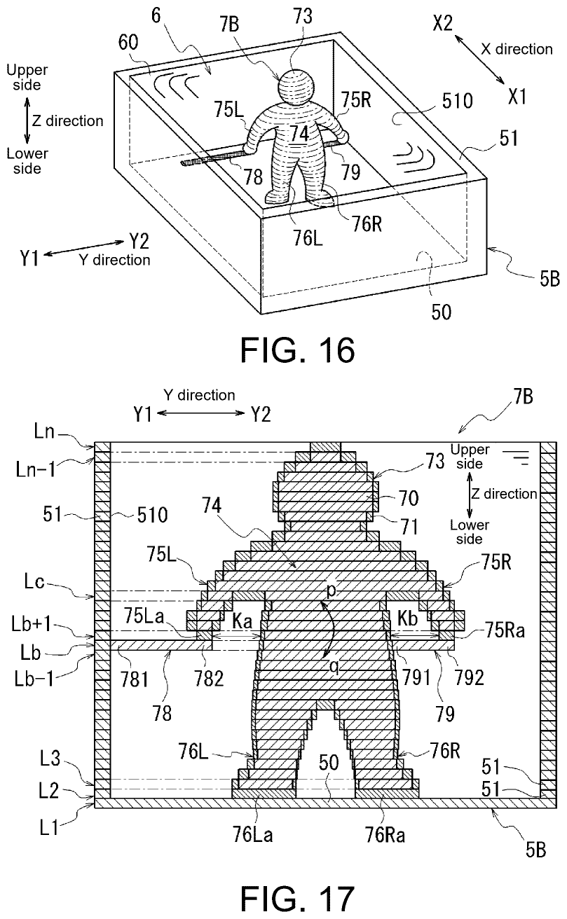

FIG. 16 is a perspective view illustrating the shaped object 7B according to Modification 6.

FIG. 17 is a view illustrating slice data of the shaped object 7B according to Modification 6.

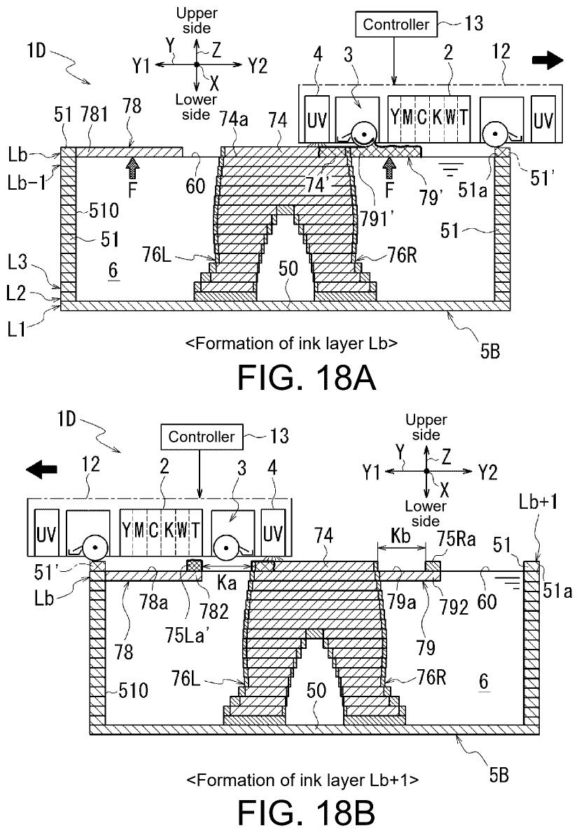

FIG. 18A and FIG. 18B are views illustrating a manufacturing method of the shaped object 7B according to Modification 6. FIG. 18A is a view illustrating formation of an ink layer Lb. FIG. 18B is a view illustrating formation of an ink layer Lb+1.

Note that, in Modification 6, a case where the shaping of the shaped object 7B and the shaping of the liquid storage 5B are performed in parallel using the manufacturing device 1D (see FIG. 11) will be described as an example.

As illustrated in FIG. 16, the humanoid shaped object 7B includes a head portion 73, a body portion 74 connected to a lower side of the head portion 73, a pair of arm portions 75L and 75R each extending from the body portion 74, and a pair of leg portions 76L and 76R. The pair of arm portions 75L and 75R are supported by the liquid storage 5B and the body portion 74 by retaining members 78 and 79 described below, respectively. As illustrated in FIG. 17, the humanoid shaped object 7B also includes a solid portion 70 and a color portion 71 that covers the solid portion 70.

As illustrated in FIG. 16, in the liquid storage 5B, the head portion 73 of the shaped object 7B is located on the liquid surface 60 (upper side) in the Z direction, and the leg portions 76L and 76R are located on the bottom wall portion 50 (lower side) in the Z direction. In addition, the arm portions 75L and 75R of the shaped object 7B are located on one side and the other side across the body portion 74 in the Y direction.

As illustrated in FIG. 17, the bottom wall portion 50 of the liquid storage 5B is formed in the ink layer L1. In the ink layer L2, a first peripheral wall portion 51 and lower end portions 76La and 76Ra of the leg portions 76L and 76R are formed. Hereinafter, inks constituting the first peripheral wall portion 51, the leg portions 76L and 76R, the body portion 74, the arm portions 75L and 75R, and the head portion 73 are sequentially layered from the ink layer L3 to the ink layer Ln.

The body portion 74 and the head portion 73 overlap the leg portions 76L and 76R fixed to the bottom wall portion 50 in the Z direction. Therefore, in the layering of the ink layers, a displacement hardly occurs at the time of flattening by the roller unit 3.

The arm portions 75L and 75R overhang from the body portion 74 in the Y direction, and extend in a direction approaching the bottom wall portion 50 as separating from the body portion 74. Distal ends 75La and 75Ra of the arm portions 75L and 75R are positioned below the connection portion with the body portion 74. Intervals between the body portion 74 and the distal ends 75La and 75Ra in the Y direction are set to Ka and Kb.

The ink layer Lb+1 in which the distal ends 75La and 75Ra of the arm portions 75L and 75R are formed is located on the lower layer than an ink layer Lc in which the connection portion with the body portion 74 is formed. Therefore, in the layering of the ink layers, the arm portions 75L and 75R are formed from the distal ends 75La and 75Ra side. In the ink layer Lb+1, the body portion 74 and the distal ends 75La and 75Ra are formed at positions separated from each other in the Y direction.

Among the portions constituting the shaped object 7B, the arm portions 75L and 75R have the thinnest shapes. In particular, in the ink layer Lb+1, the ink constituting the distal ends 75La and 75Ra is ejected in a smaller amount than the ink constituting the head portion 73, the body portion 74, and the leg portions 76L and 76R, and the contact area with the liquid 6 is also small.

Therefore, the ink constituting the distal ends 75La and 75Ra cannot be retained only by the viscosity of the liquid 6, and a displacement easily occurs at the time of flattening by the roller unit 3.

This may cause variations in the distances Ka and Kb between the body portion 74 and the distal ends 75La and 75Ra in the Y direction. Note that the bite amount Δh (see FIG. 5A) of the roller 301 can be reduced so that the distal ends 75La and 75Ra do not move, but the number of paths increases and the shaping time becomes long.

Therefore, the shaped object 7B according to Modification 6 includes the retaining members 78 and 79 that support the distal ends 75La and 75Ra of the arm portions 75L and 75R.

As illustrated in FIG. 17, the slice data of the shaped object 7B according to Modification 6 includes the shape data of the retaining members 78 and 79. The controller 13 controls the manufacturing device 1D based on the slice data of the shaped object 7B including the retaining members 78 and 79. Then, a region corresponding to the shaped object 7B and a region (retaining region) corresponding to the retaining members 78 and 79 are formed.

As illustrated in FIG. 17, the retaining members 78 and 79 are formed in the ink layer Lb. The ink layer Lb is a lower layer of the ink layer Lb+1 in which the distal ends 75La and 75Ra are formed. The retaining members 78 and 79 are formed of, for example, a white (W) ink. The retaining members 78 and 79 are cut after manufacturing the shaped object 7B.

The retaining member 78 is a pillar member extending in the direction along the Y direction and connecting the distal end 75La of the arm portion 75L and the first peripheral wall portion 51. The retaining member 78 is connected to an inner peripheral surface 510 of the first peripheral wall portion 51 at one end portion 781 in the Y direction, and is connected to the distal end 75La of the arm portion 75L at the other end portion 782.

The retaining member 79 is a pillar member extending in the direction along the Y direction and connecting the distal end 75Ra of the arm portion 75R and the body portion 74. The retaining member 79 is connected to the body portion 74 at one end portion 791 in the Y direction and is connected to the distal end 75Ra of the arm portion 75R at the other end portion 792.

As illustrated in FIG. 17, the inside of the liquid storage 5B has a region where the shaped object 7B is shaped and a region (support region) where the retaining members 78 and 79 that support the shaped object 7B are formed.

Hereinafter, a manufacturing method of the shaped object 7B by the manufacturing device 1D will be described. In the following description, the formation of the ink layers Lb and Lb+1 will be described as an example.

### Formation of Ink Layer Lb

As illustrated in FIG. 18A, the manufacturing device 1D ejects ink from the head unit 2 toward the upper surfaces 51a and 51a of the first peripheral wall portion 51, the upper surface 74a of the body portion 74, and the liquid surface 60 in the ink layer Lb−1 while moving the carriage 12 in the Y2 direction according to a command of the controller 13 (In the drawing, the black arrow).

In the ink layer Lb, the head unit 2 ejects the ink constituting each of the first peripheral wall portion 51, the retaining member 78, the body portion 74, the retaining member 79, and the first peripheral wall portion 51 in this order in the Y2 direction.

In the ink ejecting step, a step of ejecting the ink constituting the retaining members 78 and 79 corresponds to an auxiliary step.

In addition, the manufacturing device 1D sequentially flattens the first peripheral wall portion 51, the retaining member 78, the body portion 74, the retaining member 79, and the first peripheral wall portion 51 by the roller unit 3 while moving the carriage 12 in the Y2 direction, and performs curing by the ultraviolet irradiation unit 4. Thereafter, the liquid 6 is supplied from the supplying unit 8 (see FIG. 12).

In this case, one end portion 781 of the retaining member 78 is continuous from the first peripheral wall portion 51, and buoyancy Facts from the liquid surface 60. Thus, even when flattening is performed by the roller unit 3, the retaining member 78 is retained at a predetermined position on the liquid surface 60.

In addition, in the retaining member 79, one end portion 791 is continuous from the body portion 74, and buoyancy F acts from the liquid surface 60. Thus, even when flattening is performed by the roller unit 3, the retaining member 79 is retained at a predetermined position on the liquid surface 60.

Note that the body portion 74 of the ink layer Lb is continuously layered from the bottom wall portion 50 and the leg portions 76L and 76R formed on the lower layer (the ink layer L1 to the ink layer Lb−1). In addition, the first peripheral wall portion 51 of the ink layer Lb is continuously layered from the bottom wall portion 50 and the first peripheral wall portion 51 formed on the lower layer (the ink layer L1 to the ink layer Lb−1). Therefore, even when the flattening is performed by the roller unit 3, the body portion 74 and the first peripheral wall portion 51 are retained at predetermined positions.

### Formation of Ink Layer Lb+1

As illustrated in FIG. 18B, the manufacturing device 1D ejects ink from the head unit 2 toward upper surfaces 51a and 51a of the first peripheral wall portion 51, an upper surface 79a of the retaining member 79, an upper surface 74a of the body portion 74, and an upper surface 78a of the retaining member 78 in the ink layer Lb while moving the carriage 12 in the Y1 direction (In the drawing, the black arrow).

In the ink layer Lb+1, the head unit 2 sequentially ejects the ink constituting each of the first peripheral wall portion 51, the distal end 75Ra, the body portion 74, the distal end 75La, and the first peripheral wall portion 51 in the Y1 direction. In this case, the ink constituting the body portion 74 and the distal ends 75Ra and 75La is ejected to a plurality of regions (three locations) separated from each other in the Y direction.

In addition, the manufacturing device 1D sequentially flattens the first peripheral wall portion 51, the distal end 75Ra, the body portion 74, the distal end 75La, and the first peripheral wall portion 51 by the roller unit 3 while moving the carriage 12 in the Y1 direction, and performs curing by the ultraviolet irradiation unit 4. Thereafter, the liquid 6 is supplied from the supplying unit 8 (see FIG. 12).

In this case, the ink constituting the distal end 75Ra lands on the upper surface 79a on the other end portion 792 of the retaining member 79. Therefore, the distal end 75Ra is layered on the retaining member 79. In addition, the ink constituting the distal end 75La lands on the upper surface 78a on the other end portion 782 of the retaining member 78. Therefore, the distal end 75La is layered on the retaining member 78. Therefore, the ink constituting the distal ends 75La and 75Ra is continuously layered from the lower layer side (the ink layer L1 to the ink layer Lb).

Thus, the contact pressure applied to the distal ends 75La and 75Ra at the time of flattening can be received on the lower layer side via the retaining members 78 and 79, and the positions of the distal ends 75La and 75Ra are hardly displaced. Therefore, the distances Ka and Kb between the body portion 74 and the distal ends 75La and 75Ra in the Y direction hardly vary.

Thus, the ink layer is further layered on the distal ends 75La and 75Ra, such that the shaping accuracy of the entire arm portions 75L and 75R, which are overhang regions, of the shaped object 7B is improved.

Therefore, the distances Ka and Kb between the inks ejected to the plurality of regions (the body portion 74 and the distal ends 75La and 75Ra) separated in the Y direction can be reduced from varying without using a support material that covers the shaped object 7B.

In addition, the retaining members 78 and 79 are provided in a direction along the Y direction. Therefore, it is possible to resist the pressing force in the Y direction applied from the roller unit 3 to the distal ends 75La and 75Ra, and the rigidity at the time of shaping is increased to make it more difficult to vary.

Here, in the shaped object 7B, a bending moment generated in the shaped object 7B at the time of flattening by the roller unit 3 (force point) increases as the shaped object 7B moves away from the bottom wall portion 50 (fulcrum) in the Z direction (for example, the head portion 73). In this case, at the time of flattening, the shaped object 7B cannot be retained only by the viscosity of the liquid 6, and the shaped object 7B may move or collapse in the liquid storage 5B.

Therefore, as illustrated in FIG. 17, the shaped object 7B is provided with the retaining member 78 that connects the distal end 75La of the arm portion 75L and the inner peripheral surface 510 of the liquid storage 5B. Thus, when the head portion 73 is flattened, the bending moment generated in the shaped object 7B becomes a fulcrum with the retaining member 78 as a fulcrum (the arrows p and q in FIG. 17). Since the distance between the fulcrum and the force point becomes short, the bending moment with the retaining member 78 as a fulcrum is smaller than the bending moment with the bottom wall portion 50 as a fulcrum. Therefore, the shaped object 7B can be reduced from moving or falling in the liquid storage 5B at the time of flattening.

### Modification 7

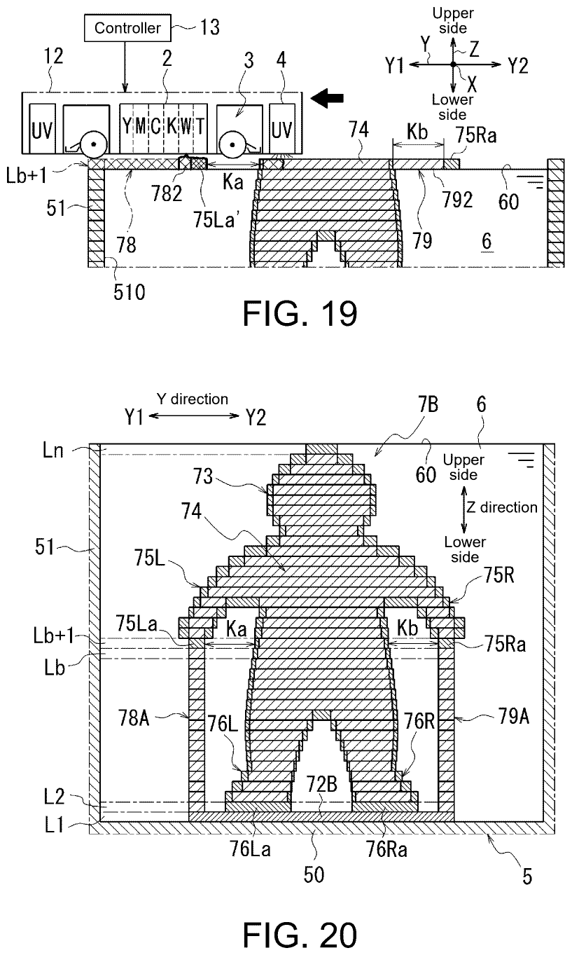

FIG. 19 is a view illustrating a manufacturing method of the shaped object 7B according to Modification 7.

In Modification 6, the distal ends 75La and 75Ra of the arm portions 75L and 75R of the ink layer Lb+1 are layered on the retaining members 78 and 79 formed in the ink layer Lb, but the present invention is not limited to this mode. As illustrated in FIG. 19, the retaining members 78 and 79 may be formed in the ink layer Lb+1, and the distal ends 75La and 75Ra may be connected to the other end portions 781 and 792 of the retaining members 78 and 79, respectively.

In this case, in the formation of the ink layer Lb+1, the step of ejecting the ink of the distal ends 75La and 75Ra (ejecting step) includes a step of ejecting the ink of the retaining members 78 and 79 (auxiliary step).

Thus, the distal end 75La is integrally formed with the retaining member 78 in the Y direction to be retained. The distal end 75Ra is integrally formed with the retaining member 79 in the Y direction to be retained. The distal ends 75La and 75Ra are connected to the liquid storage 5B and the body portion 74 via the retaining members 78 and 79, respectively.

Therefore, the positions of the distal ends 75La and 75Ra are hardly displaced. Therefore, the distances Ka and Kb between the body portion 74 and the distal ends 75La and 75Ra in the Y direction hardly vary.

Note that, in Modifications 6 and 7, the retaining member 78 connects the arm portion 75L and the inner peripheral surface 510 of the liquid storage 5B, and the retaining member 79 connects the arm portion 75R and the body portion 74 (see FIGS. 16 to 19), but the present invention is not limited to this mode. The retaining members 78 and 79 may connect the arm portions 75L and 75R and the inner peripheral surface 510 of the liquid storage 5B, respectively. In addition, the retaining members 78 and 79 may connect the arm portions 75L and 75R and the body portion 74, respectively. The number of retaining members and the connection direction can be appropriately changed based on the weight, volume, and shape of the shaped object, the viscosity of the liquid 6, and the like.

### Modification 8

As illustrated in FIG. 20, the shaped object 7B may be manufactured in the liquid storage 5 filled with the liquid 6 in advance using the manufacturing device 1 (see FIG. 1A and FIG. 1B).

FIG. 20 is a view illustrating a manufacturing method of the shaped object 7B according to Modification 8.

As illustrated in FIG. 20, the shaped object 7B is provided on the ejection table 72A. In the shaped object 7B, the lower end portions 76La and 76Ra of the leg portions 76L and 76R are connected to the ejection table 72A.

The ejection table 72A is provided in a range crossing the leg portions 76L and 76R in the Y direction and overlapping the distal ends 75La and 75Ra of the arm portions 75L and 75R.

Retaining members 78A and 79A are provided between the ejection table 72A and the distal ends 75La and 75Ra of the arm portions 75L and 75R in the Z direction. The retaining members 78A and 79A are provided in a direction along the Z direction. The retaining members 78A and 79A may be formed of a white (W) ink, or may be formed of the same ink as the ejection table 72A.

In the manufacturing method of the shaped object 7B according to Modification 8, first, the ejection table 72A is formed as the ink layer L1. Next, as the ink layer L2, the retaining members 78A and 79A and the leg portions 76L and 76R are formed on the ejection table 72A. Hereinafter, the ink layers are sequentially layered up to the ink layer Ln.

As illustrated in FIG. 20, the retaining members 78A and 79A have areas substantially matching the distal ends 75La and 75Ra of the arm portions 75L and 76R in the Y direction. The retaining members 78A and 79A are layered in a range of the ink layer L2 to the ink layer Lb.

Thus, in the formation of the ink layer Lb+1, the ink constituting the distal ends 75La and 75Ra lands on the upper surfaces of the retaining members 78A and 79A. The distal ends 75La and 75Ra are layered on the retaining members 78A and 79A. Therefore, the ink constituting the distal ends 75La and 75Ra is continuously layered from the lower layer side (the ink layer L1 to the ink layer Lb).

Thus, in the formation of the ink layer Lb+1, the contact pressure applied to the distal ends 75La and 75Ra at the time of flattening can be received on the lower layer side via the retaining members 78A and 79A, and the positions of the distal ends 75La and 75Ra are hardly displaced. Therefore, the distances Ka and Kb between the body portion 74 and the distal ends 75La and 75Ra in the Y direction are reduced from varying.

In the embodiment and the modifications described above, the case where the head unit 2 is an inkjet head is exemplified, but the present invention is not limited to this mode. For example, the head unit 2 may be a dispenser, a spray gun, or the like.

As described above, the embodiment and the modification of the present invention have been described. The present invention is not limited only to the modes of these embodiments and modifications. The embodiments and modifications described above may be arbitrarily combined.

Although the embodiment of the present invention has been described above, the above embodiment merely shows one application example of the present invention, and the technical scope of the present invention is not intended to be limited to the specific configuration of the above embodiment. Modifications can be made as appropriate within the scope of the technical idea of the invention.

1. A shaped-object manufacturing device that shapes a three-dimensional shaped object, the shaped-object manufacturing device comprising:
a liquid storage that retains a liquid;
an ejector that ejects an ink to the liquid; and
a roller that comes into contact with the ink retained by a liquid surface of the liquid.

2. The shaped-object manufacturing device as set forth in claim 1, wherein the roller is provided to be relatively movable with respect to the liquid storage, and
when viewed from the liquid storage, the roller rotates so that a portion in contact with the ink is oriented in a direction of the relative movement.

3. The shaped-object manufacturing device as set forth in claim 1, wherein the roller is provided to be relatively movable with respect to the liquid storage, and
when viewed from the liquid storage, the roller rotates so that a portion in contact with the ink is oriented in a direction opposite to the direction of the relative movement.

4. The shaped-object manufacturing device as set forth in claim 1, wherein the roller includes an adjustment mechanism that adjusts a contact pressure with the ink.

5. The shaped-object manufacturing device as set forth in claim 1, further comprising a curing unit that cures the ink.

6. The shaped-object manufacturing device as set forth in claim 1, wherein the ejector is an inkjet head.

7. A shaped-object manufacturing method for shaping a three-dimensional shaped object, the shaped-object manufacturing method comprising:
an ejecting step of ejecting an ink to a liquid stored in a liquid storage;
a flattening step of flattening the ink retained by a liquid surface of the liquid by a roller; and
a curing step of curing the flattened ink to form an ink layer.

8. The shaped-object manufacturing method as set forth in claim 7, wherein the roller is moved relative to the liquid storage, and
when viewed from the liquid storage, the roller is rotated so that a portion in contact with the ink is oriented in a direction of the relative movement.

9. The shaped-object manufacturing method as set forth in claim 7, wherein the roller is moved relative to the liquid storage, and
when viewed from the liquid storage, the roller is rotated so that a portion in contact with the ink is oriented in a direction opposite to the direction of the relative movement.

10. The shaped-object manufacturing method as set forth in claim 7, further comprising an adjustment step of adjusting a contact pressure between the roller and the ink.

11. The shaped-object manufacturing method as set forth in claim 7, wherein a method for ejecting the ink is an inkjet method.

12. The shaped-object manufacturing device as set forth in claim 2, wherein the roller includes an adjustment mechanism that adjusts a contact pressure with the ink.

13. The shaped-object manufacturing device as set forth in claim 3, wherein the roller includes an adjustment mechanism that adjusts a contact pressure with the ink.

14. The shaped-object manufacturing method as set forth in claim 8, further comprising an adjustment step of adjusting a contact pressure between the roller and the ink.

15. The shaped-object manufacturing method as set forth in claim 9, further comprising an adjustment step of adjusting a contact pressure between the roller and the ink.
